(19) United States
(12) Patent Application Publication
(10) Pub. No.: US 2024/0355239 A1
(43) Pub. Date: Oct. 24, 2024

(54) AR MIRROR

(71) Applicants: Shree K. Nayar, New York, NY (US); Gurunandan Krishnan Gorumkonda, Kirkland, WA (US); Jian Wang, West New York, NJ (US); Bing Zhou, Rye, NY (US); Sizhuo Ma, Long Island City, NY (US); Karl Bayer, Brooklyn, NY (US); Yicheng Wu, Belmont, MA (US)

(72) Inventors: Shree K. Nayar, New York, NY (US); Gurunandan Krishnan Gorumkonda, Kirkland, WA (US); Jian Wang, West New York, NJ (US); Bing Zhou, Rye, NY (US); Sizhuo Ma, Long Island City, NY (US); Karl Bayer, Brooklyn, NY (US); Yicheng Wu, Belmont, MA (US)

(21) Appl. No.: 18/638,553

(22) Filed: Apr. 17, 2024

Related U.S. Application Data
(60) Provisional application No. 63/460,200, filed on Apr. 18, 2023.

(51) Int. Cl. G09G 3/00; G06F 3/01; G06T 3/60; G06T 5/60

(52) U.S. Cl. CPC G09G 3/001; G06F 3/013; G06T 3/60; G06T 5/60; G06T 2200/24; G06T 2207/20081; G06T 2207/30196; G09G 2340/0492; G09G 2354/00

(57) ABSTRACT

An under-screen camera is provided. A camera is positioned behind a see-through display screen and positioned to capture scene image data of objects in front of the display screen. The camera captures scene image data of a real-world scene including a user. The scene image data is processed to remove artifacts in the scene image data created by capturing the scene image data through the see-through display screen such as blur, noise, backscatter, wiring effect, and the like.

### PRIORITY CLAIM

This application claims the benefit of U.S. Provisional Application No. 63/460,200, filed on Apr. 18, 2023, which is hereby incorporated by reference in its entirety.

### TECHNICAL FIELD

The present disclosure relates generally to image processing and more particularly to restoration of degraded images used for augmented reality.

### BACKGROUND

In Augmented Reality (AR) imaging systems, images of a scene are captured and then used to generate an AR experience for a user. However, the captured images may be degraded due to various factors such as noise, blurring, and distortion. These degraded images may hinder the analysis and subsequent use of the captured images.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1A is a diagram of an AR system implementing an AR mirror, according to some examples.

FIG. 1B is a is a diagram of an under-display camera system, according to some examples.

FIG. 1C is an illustration of a degraded input image being restored, according to some examples.

FIG. 1D is an illustration of an input image being distorted by an image capturing artifact, according to some examples.

FIG. 1E is an illustration of an input image being distorted by another image capturing artifact, according to some examples.

FIG. 1F is an illustration of an input image being distorted by another image capturing artifact, according to some examples.

FIG. 2 is a collaboration diagram of an image processing pipeline, according to some examples.

FIG. 3A is a collaboration diagram of components of an AR system implementing an AR mirror, according to some examples.

FIG. 3B is an activity diagram of an AR mirror method, according to some examples.

FIG. 3C is an activity diagram of an under-display camera system, according to some examples.

FIG. 4 is an illustration of an eye level detection system, according to some examples.

FIG. 5 is an illustration of another eye level detection system, according to some examples.

FIG. 6 is an illustration of a camera height adjustment system, according to some examples.

FIG. 7A illustrates a multi-camera configuration of an AR system, according to some examples.

FIG. 7B illustrates another multi-camera configuration of an AR system, according to some examples.

FIG. 8 is an illustration of reference cameras used by an AR system, according to some examples.

FIG. 9 is a diagram of a see-through projection screen, accordance with some examples.

FIG. 10A is a diagram of an encoder-decoder network of a restoration model, according to some examples.

FIG. 10B is a diagram of a block of an encoder-decoder network of a restoration model, according to some examples.

FIG. 11 is process flow diagram of a restoration model training method, according to some examples.

FIG. 12 is a diagrammatic representation of a machine in the form of a computer system within which a set of instructions may be executed to cause the machine to perform any one or more of the methodologies discussed herein, according to some examples.

FIG. 13 is a diagrammatic representation of a networked environment in which the present disclosure may be deployed, according to some examples.

FIG. 14 is a diagrammatic representation of a data structure as maintained in a database, according to some examples.

FIG. 15 is a diagrammatic representation of a messaging system that has both client-side and server-side functionality, according to some examples.

FIG. 16 is a block diagram showing a software architecture, according to some examples.

### DETAILED DESCRIPTION

An Augmented Reality (AR) system may be used to provide an AR mirror experience to a user where the user is able to see themselves as if they are looking into a mirror. AR augmentations may then be added to the AR mirror image of the user provided to the user by the AR system. In order for the AR mirror experience to be convincing to the user, the AR mirror image should be presented to the user as if the user were looking directly into a mirror, or in the case of the AR system, directly into a camera being used to capture scene image data including image data of the user. To achieve this effect, an AR system in accordance with the disclosure uses one or more cameras located behind a see-through display screen to capture scene image data that is then used to generate an AR mirror experience for a user.

In some examples, an AR system provides an AR user interface to a user where the AR user interface is displayed on a see-through display screen. The AR system captures, using one or more cameras located behind the see-through display screen, scene image data of a real-world scene including the user. The AR system generates pre-processed scene image data using the scene image data, generates restored scene image data using the pre-processed scene image data and a model trained to restore the scene image data. The AR system generates mirror image data using the restored scene image data and generates AR mirror image data using the mirror image data. The AR system provides an AR mirror image to the user using the AR mirror image data and the AR user interface.

In some examples, the AR system captures, using one or more user-reference cameras, user image data and determines an eye level of the user using the user image data. The AR system automatically positions the one or more cameras at the eye level of the user.

Other technical features may be readily apparent to one skilled in the art from the following figures, descriptions, and claims.

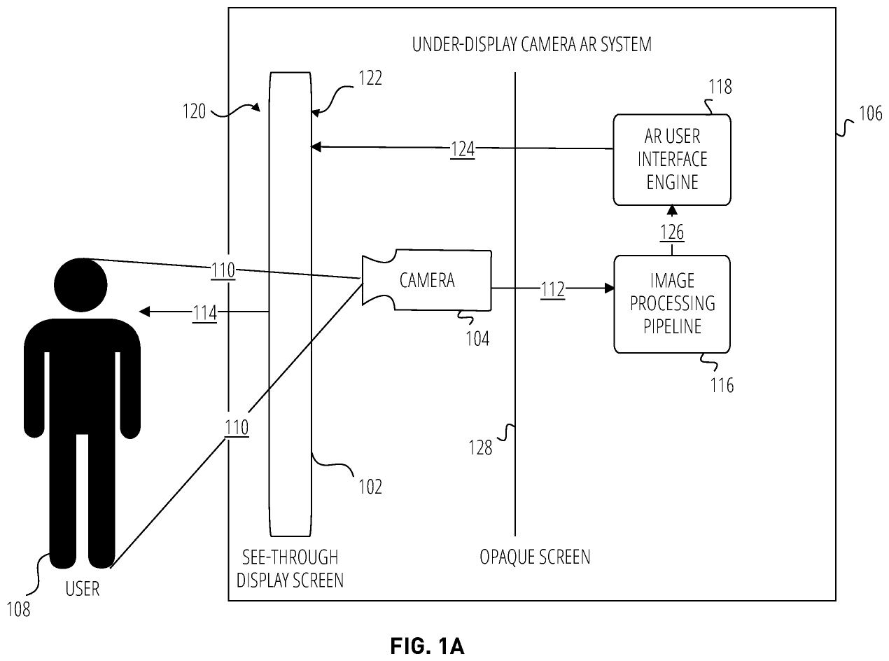

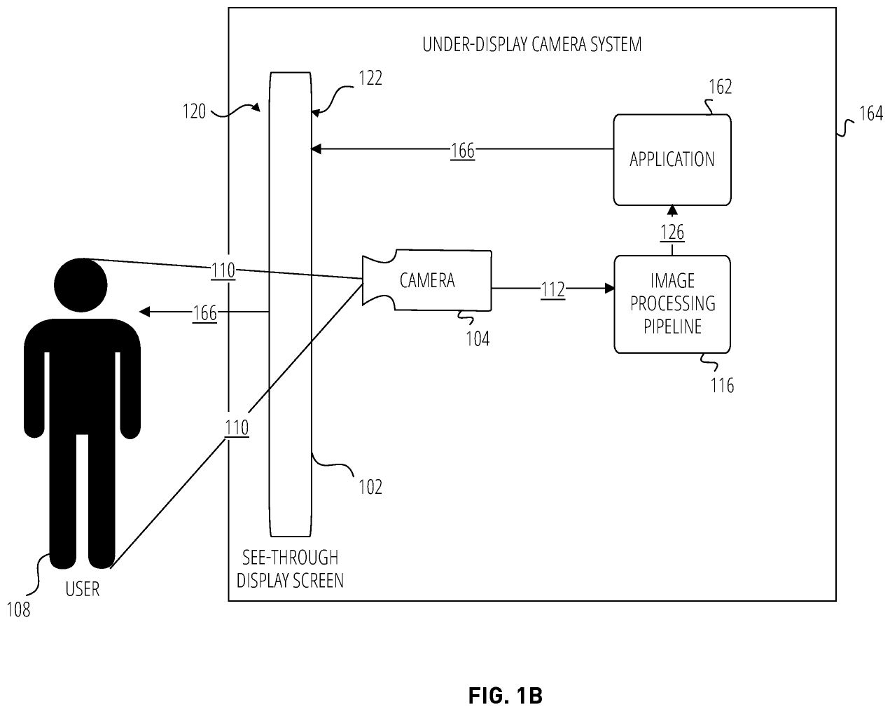

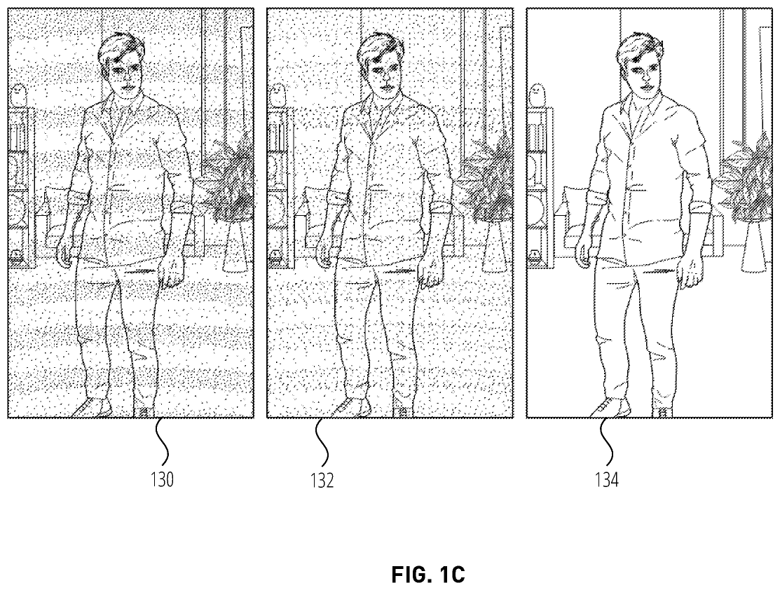

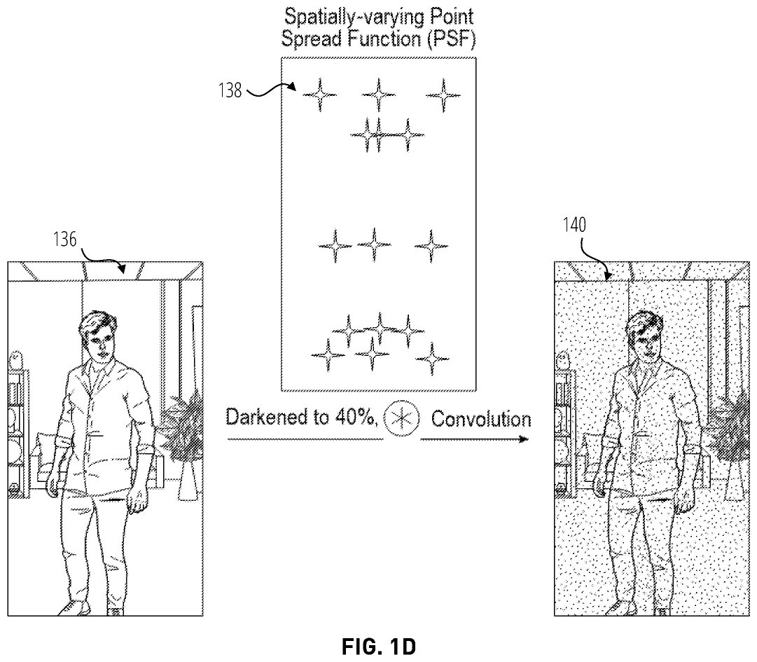

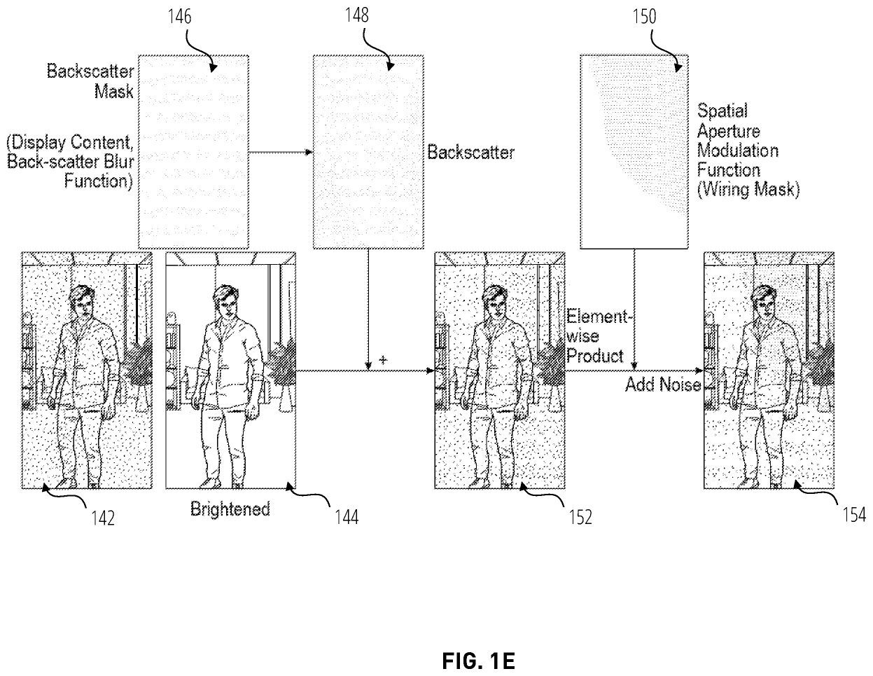

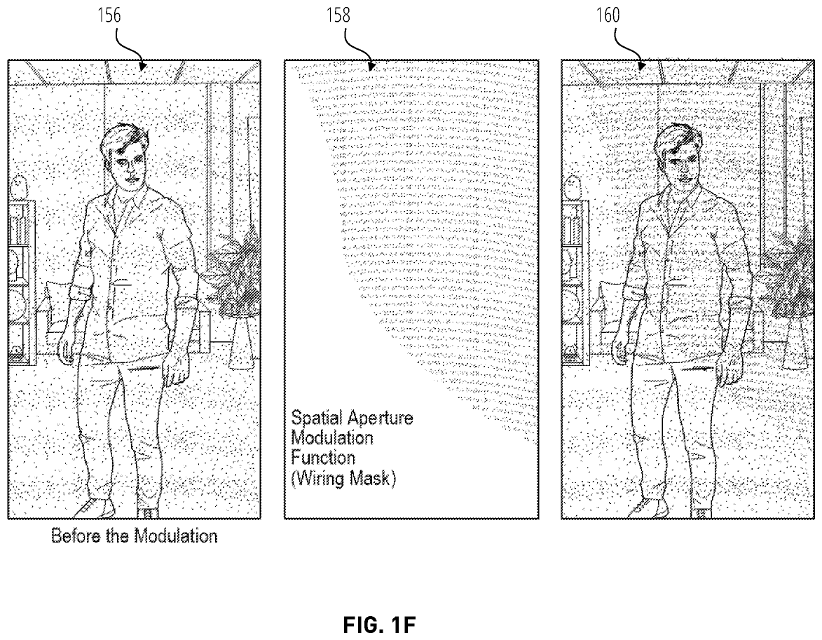

FIG. 1A is a diagram of an AR system, according to some examples. An under-display camera AR system 106 includes a see-through display screen 102 positioned to be seen by a user 108 as if the user 108 were in front of a mirror in which the user 108 may see themselves. The see-through display screen 102 displays content to the user 108 on a display surface 120. The see-through display screen 102 is constructed from transparent materials, such as glass or plastic, and is coated with a transparent conducting material such as, but not limited to, indium tin oxide (ITO) or the like, to enable the display of images. Display technologies suitable for use in the see-through display screen 102 include, but are not limited to, OLED, LCD, and the like. In some examples, the see-through display screen 102 allows light of a real-world scene of the user 108 to pass through the display surface 120 and a non-display surface 122 of the see-through display screen 102. In some examples, a partially reflective mirror, or beamsplitter, reflects the light from the display surface 120 back to the eyes of the user 108 while allowing some light from the real-world scene to pass through to the non-display surface 122.

In some examples, the see-through display screen 102 includes a single screen. In some examples, the see-through display screen 102 includes two more see-through display screens that are tiled so as to create a single see-through display screen 102. In some examples, the see-through display screen 102 is attached to an anti-reflection film in the frontal surface to let more display light out to decrease backscatter light to the camera (here backscatter light refers to some display light which is bounced back towards the back of the display and enters the camera). In some examples, the see-through display screen 102 runs at higher than 60 Hz, for example 120 Hz. The see-through display screen 102 and the one or more cameras 104 are synchronized and they work in an interleaving way to avoid backscatter (for example, the one or more cameras 104 and the see-through display 102 operate at 120 Hz, but in opposite phase where, when the display shows the AR mirror image 114, the one or more cameras 104 do not capture scene image data 112, and when the display does not show the AR mirror image 114, the one or more cameras 104 capture scene image data 112.

In some examples, the one or more cameras 104 may comprise, RGB cameras, RGB-NIR cameras, RGB-D (depth cameras), and the like.

In some examples, the one or more cameras 104 have a Field of View (FoV) that permits a user to see their face and upper body in the see-through display screen 102. In some examples, the one or more cameras 104 have a FoV that permits a user to see their entire body in the see-through display screen 102.

In some examples, the see-through display screen 102 is comprised of their face and upper body in the see-through display screen 102 such that a user can see themselves in full. In some examples, the see-through display screen 102 is comprised of a plurality of screens that are arranged in a gridded structure so as to appear as a single large screen in portrait mode. In some examples, the see-through display screen 102 is a single screen mounted such that the user sees just their upper body mirrored in the see-through display screen 102.

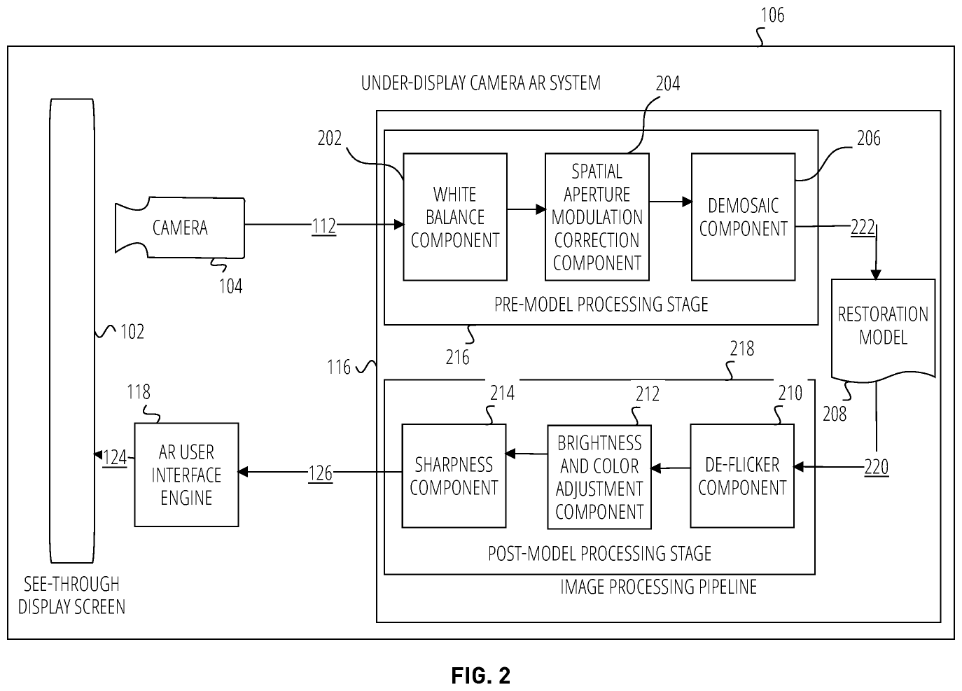

The under-display camera AR system 106 further includes a camera 104 located on the non-display surface 122 side of the see-through display screen 102 and positioned to capture scene images 110 of the real-world scene including images of the user 108. The under-display camera AR system 106 uses the camera 104 to capture scene image data 112 that the under-display camera AR system 106 processes using an image processing pipeline 116 to generate corrected real world scene data 126 as described in reference to FIG. 2, and uses the corrected real world scene data 126 to generate AR mirror image data 124 as also described in reference to FIG. 2.

In some examples, a black opaque screen 128 is positioned behind the camera 104.

FIG. 1B is a diagram of an under-display camera system 164, in accordance with some examples. The under-display camera system 164 incorporates the elements of the under-display camera AR system 106 including a see-through display screen 102 positioned to be seen by a user 108. The see-through display screen 102 displays application image data 166 generated by an application 162 to the user 108 on a display surface 120. The application 162 can be any kind of application that uses image content captured of the user 108 as the user views the application image data 166 generated by the application 162.

The under-display camera system 164 further includes a camera 104 located on the non-display surface 122 side of the see-through display screen 102 and positioned to capture scene images 110 of the real-world scene including images of the user 108. The under-display camera system 164 uses the camera 104 to capture scene image data 112 that the under-display camera system 164 processes using an image processing pipeline 116 to generate corrected real-world scene image data 126 as more fully described in reference to FIG. 2.

In some examples, the application 162 is a software application that utilizes both the display of image content to a user and the simultaneous capture of video images of the user. This dual functionality is particularly useful in various interactive scenarios where the user's image is an integral part of the application experience. Example applications include, but are not limited to:

Teleconferencing: In a teleconferencing application, the user 108 can engage in a video call where they see other participants on their display while their own image is captured and transmitted to others. This allows for a more natural conversation experience, as if the participants were in the same room. The application 162 may include features such as background blur or replacement, real-time facial enhancements, and eye contact correction to improve the visual communication experience.

Gaming: In interactive gaming, especially in augmented reality (AR) or virtual reality (VR) environments, the user's image can be captured and integrated into the game. For instance, the user's facial expressions could be mapped onto an avatar in real-time, allowing for more immersive and personalized gameplay. Additionally, the user may stream their gameplay to an audience, with their live image overlaid on the game content.

Virtual Try-On: Retail applications may offer a virtual try-on feature where users can see themselves wearing different items such as glasses, hats, or makeup. The application captures the user's image and applies the virtual products to their likeness on the screen, providing an interactive shopping experience.

Fitness and Health: Fitness applications might use the camera to capture the user's movements for real-time feedback during exercise routines. Similarly, health applications could monitor the user's physical responses or conduct remote consultations where both the patient and healthcare provider need to see each other.

Education and Training: Educational applications can benefit from this technology by allowing students to participate in virtual classrooms where they can be seen by the instructor and peers. Training simulations may also use the user's image to provide personalized feedback or to simulate interactions with virtual characters.

Content Creation: For content creators, applications that offer live broadcasting or recording features can capture the user's image while they interact with or comment on the content being displayed. This is common in live streaming platforms where the broadcaster's image is shown alongside the main content.

Social Media: Social media applications often have features that allow users to capture their reactions to content or to participate in video chats. The user's image is a part of the shared content, enhancing the social interaction.

In these examples, the application 162 leverages the simultaneous display of application image data 166 to the user 108 and the capture of the user's image to create a more engaging and interactive experience.

Capturing the scene image data 112 using the camera 104 introduces artifacts into the scene image data 112 as the see-through display screen 102 is not perfectly transparent, and computer vision processing methodologies are used to restore the captured image as illustrated in FIG. 1C. The formation of the scene image data 112 can be modeled as:

$$y \approx C [ μ \{ ( x ⊗ h ) + α ( b ⊗ k ) \} + η ]$$

### Where:

[symbol] =captured scene image data 112
x=clean scene image data without any artifacts
h=display point spread function that is spatially-varying
μ=spatial aperture modulation function or wiring mask
b=displayed AR mirror image
k=back-scatter blur function
α=spatial back-scatter modulation function or backscatter mask
C=clipping scene image data to 8 or 12 bit resolution
η=noise including photon noise and camera's readout noise

The display point spread function is a function used to model the blurring effect of the see-through display screen 102 on the captured scene image data 112. The display point spread function describes how the see-through display screen 102 introduces artifacts into scene image data 112 because of the display structure of pixels of the display surface 120 of the display screen. The point spread function is spatially-varying. In some examples, the display point spread function is a two-dimensional convolution function that takes into account a size and shape of the display pixels, as well as a distance between the pixels. In some examples, the display point spread function includes a Gaussian function modeling the blurring effect as a smooth function. An example is illustrated in FIG. 1D.

The spatial aperture modulation function or wiring mask models a lensing effect of the structure of the display elements of see-through display screen 102 on image brightness. When light passes through the see-through display screen 102, it is affected by the display elements, which can cause spatially-varying brightness in the scene image data 112 as illustrated in FIG. 1E.

The back-scatter blur function models the effect that back-scatter of the displayed AR mirror image data 124 has on the captured scene image data 112.

The spatial back-scatter modulation function or backscatter mask models an amount of back-scatter based on the spatial relationships between the see-through display screen 102 and the camera 104. A visual example is shown in FIG. 1B

A “blind” restoration of the scene image data using an encoder-decoder network can be modeled as:

$$\tilde{x} = f ( y ; θ )$$

### Where:

\tilde{x}=restored scene image data
f=encoder-decoder network of a restoration model
[symbol] =captured scene image data 112
θ=network weights of the encoder-decoder network of the restoration model

An encoder-decoder network is used to generate restored scene image data using the scene image data 112 and the network weights of the encoder-decoder model as more fully described in reference to FIG. 2.

In some examples, digital image processing methods such as, but not limited to, a Wiener deconvolution filter and the like, are applied first and then a network is applied to solve the residual problem. In this way, a processing load of restoring a scene image from a captured scene image may be reduced. For example, a restoration process using digital imaging processing methods first can be modeled as:

$$\tilde{x} = f ( T ( y ) ; θ )$$

### Where:

\tilde{x}=restored scene image data
f=encoder-decoder network of a restoration model
T=digital image processing methods
[symbol] =captured scene image data 112
θ=network weights of the encoder-decoder network of the restoration model

In some examples, coordinates of pixels are also input to the convolutional neural network so that the net is aware of different operations in different pixel locations. For example, a restoration process incorporating pixel locations can be modeled as:

$$\tilde{x} = f ( y , X , Y ; θ )$$

### Where:

\tilde{x}=restored scene image data
f=encoder-decoder network of a restoration model
[symbol] =captured scene image data 112
X=x coordinates of all pixels
Y=y coordinates of all pixels
θ=network weights of the encoder-decoder network of the restoration model

In some examples, information about how artifacts in the scene image data 112 were introduced can be used to perform an improved restoration process of the scene image data from the captured scene image data. For example, a restoration process incorporating image capture information can be modeled as:

$$\tilde{x} = f ( y , μ , h , b , α ; θ )$$

### Where:

\tilde{x}=the restored scene image data
f=the encoder-decoder network of the restoration model
[symbol] =captured scene image data 112
μ=the spatial aperture modulation function or wiring mask
h=the display point spread function
b=the displayed AR mirror image
α=spatial back-scatter modulation function or backscatter mask
θ=the network weights of encoder-decoder network of the restoration model

In some examples, the image processing pipeline 116 uses an enhanced encoder-decoder network of a restoration model to generate restored scene image data as described in FIG. 2.

In some examples, one or more reference cameras are used to provide reference images for image restoration. When using the one or more reference cameras, a restoration process can be modeled as:

$$\tilde{x} = f ( y , μ , h , b , α , z ; θ )$$

### Where:

\tilde{x}=the restored scene image data
f=the encoder-decoder network of the restoration model
[symbol] =captured scene image data 112
μ=the spatial aperture modulation function or wiring mask
h=the display point spread function
b=the displayed AR mirror image
α=spatial back-scatter modulation function (or called backscatter mask)
z=captured reference image
θ=the network weights of encoder-decoder network of the restoration model

In some examples, one or more previous frames of captured scene image data and/or one or more previous restored frames of restored scene image data are used to provide temporal information for current frame's image restoration. When using previous frame(s)′ information, restoration can be modeled as:

$${\tilde{x}}_{t} = f ( {y}_{t} , μ , h , b , α , {y}_{t - 1 , … , t - k} , {\tilde{x}}_{t - 1 , … , t - k} ; θ )$$

### Where:

\tilde{x}ₜ=the restored scene image data of current frame at time t
f=the encoder-decoder network of the restoration model
yₜ=captured scene image data 112 of current frame at time t
μ=the spatial aperture modulation function or wiring mask
h=the display point spread function
b=the displayed AR mirror image
α=spatial back-scatter modulation function or backscatter mask
y_{t-1, . . . ,t-k}=previous k frames from time t−1 to time t−k
\tilde{y}_{t1, . . . ,t-k}=previous restored k frames from time t−1 to time t−k
θ=the network weights of encoder-decoder network of the restoration model

In some examples, an under-display camera system uses various functions, models, and masks to perform a restoration process on a captured scene image such as, but not limited to, one or more display point spread functions, one or more backscatter masks, one or more wiring masks, and the like. In some examples, these various functions, models, and masks can be determined during a calibration process. In some examples, such as after a physical event such as, but not limited to vibration caused by movement of the see-through display screen 102 or one or more cameras 104, a recalibration or self-calibration is performed by the under-display camera system to correct the calibration.

FIG. 1C is an illustration of a degraded input image being restored, according to some examples. An under-display camera system captures a captured scene image 130, applies one or more image processing methods to the captured scene image 130, as illustrated by brightened scene image 132, to generate a restored scene image 134 as described in more detail in reference to FIG. 2.

FIG. 1D is an illustration of an image being distorted by an image capturing artifact, according to some examples. A scene image 136 may be distorted by a spatially-varying point spread effect 138 resulting in a blurred scene image 140.

FIG. 1E is an illustration of an input image being distorted by another image capturing artifact, in accordance with some examples. In some examples, a captured scene image 142 is partially restored by a brightening process to generate a brightened scene image 144 that is displayed to a user of an under-display camera system. The displayed brightened scene image 144 generates backscatter 146 and 148 that causes a degradation of a scene image being captured, as illustrated by degraded image 152. In addition, a spatial aperture modulation distortion, as illustrated by wiring mask 150 caused by the physical structure of a see-through display screen 102 further changes the brightness of the image spatially and causes a wiring effect as illustrated by captured scene image 154.

FIG. 1F is an illustration of an input image being distorted by another image capturing artifact, according to some examples. A wiring distortion effect is visual artifact that can occur when capturing images through a display screen, such as with an under-display camera system. This effect is a result of the physical structure of the display itself, which can include elements like wiring or other components that are part of the display's construction. When light passes through the display screen to reach the camera, the presence of these structural elements can cause variations in brightness across the captured image, creating patterns or bands that can degrade the quality of the image. These patterns are often regular and grid-like, corresponding to the layout of the wiring or pixel structure of the display, hence the term ‘wiring effect.’ A scene image 156 may be degraded by a spatial aperture modulation effect, as illustrated by special aperture modulation function or wiring mask 158, to generate a degraded scene image 160 having a wiring effect.

FIG. 2 is a collaboration diagram of an image processing pipeline, according to some examples. An under-display camera system uses the image processing pipeline 116 to generate corrected real world scene data 126.

In some examples, an under-display camera system is a component of another system such as, but not limited to, under-display camera AR system 106. The under-display camera AR system 106 incorporates an under-display camera system to generate AR mirror image data 124 of an AR mirror image 114 (of FIG. 1A) that is displayed to a user using a see-through display screen 102.

In some examples, the corrected real world scene data 126 is used by an application, such as application 162 of FIG. 1B, for various other types of purposes as more fully described in reference to FIG. 1B.

The image processing pipeline 116 includes a pre-model processing stage 216 that processes scene image data 112 captured by one or more cameras 104 of the under-display camera system, a restoration model 208 that generates restored scene image data 220 using the pre-processed scene image data 222, and a post-model processing stage 218 that generates corrected real world scene data 126 using the restored scene image data 220.

The pre-model processing stage 216 includes a white balance component 202 that adjusts colors in a scene image of the scene image data 112 to ensure that white is perceived as white, regardless of the light source or lighting conditions under which the scene image data 112 is captured. The color of light can vary depending on the light source, such as natural daylight, fluorescent lighting, or incandescent bulbs, which can affect the colors in an image. A white balance of the scene image of the scene image data 112 is used to correct these color casts and ensure that the colors in the image are accurate and natural-looking. For example, the white balance component 202 adjusts the color balance of a scene image so that a brightest point in the scene image appears white, and all other colors are adjusted accordingly. As a result, an overall color temperature of the image is consistent with lighting conditions under which the scene image was captured.

The pre-model processing stage 216 further includes a spatial aperture modulation correction component 204 that corrects for the wiring effect created by the gridded display elements of the see-through display screen 102. For example, a spatial aperture modulation function of the see-through display screen 102 is determined through measurement by capturing an image of a uniform white wall or a uniform LED panel placed in front of the display or calculation of the see-through display screen 102 that describes the lensing effect of the see-through display screen 102 at different spatial locations of the camera image. The spatial aperture modulation function is used to correct the scene image data 112 for wiring effect that occurs because of the lensing effect of the see-through display screen 102.

The pre-model processing stage 216 further includes a demosaic component 206 that converts scene image data that has been captured by a Color Filter Array (CFA) into a full-color image. In some examples, a CFA is a mosaic of color filters such as a red filter, a green filter, a blue filter, and the like, that are placed over individual pixels of an image sensor of the camera 104. When light enters the camera 104 and passes through the CFA, only certain color information is captured at each pixel, resulting in a monochromatic or incomplete image. To create a full-color image, the demosaic component 206 takes into account neighboring pixels that have captured different color information and interpolates missing color values. For example, the demosaic component 206 analyzes the patterns and colors in a scene image and estimates values of missing color channels.

The pre-model processing stage 216 generates pre-processed scene image data 222 that is used by a restoration model 208 to generate restored scene image data 220 using the pre-processed scene image data 222 and an encoder-decoder network.

An encoder-decoder network is a type of neural network architecture used in image-to-image translation tasks. An encoder encodes the pre-processed scene image data 222 into a fixed-length vector or context vector (or map). In some examples, this is done using multiple rounds of a convolutional neural network (CNN), diffusion models, transformer models. or the like, and downsampling, that processes the pre-processed scene image data 222 and produces feature maps with smaller spatial dimension and higher feature dimension in each round sequentially. The final feature map of the encoder is used as the context vector (map).

The decoder uses the context vector (map) to generate restored scene image data 220. The decoder is also typically implemented as multiple rounds of upsampling and a CNN. The decoder starts with the context vector (map), upsamples it, processes the upsampled feature map into another feature map thus obtaining higher spatial dimension and lower feature dimension in each round and generates the restored scene image data 220 until it reaches the last round.

In some examples, the restoration model 208 includes, but is not limited to, a neural network, a learning vector quantization network, a logistic regression model, a support vector machine, a random decision forest, a naïve Bayes model, a linear discriminant analysis model, and a K-nearest neighbor model. In some examples, machine learning methodologies used to generate the restoration model 208 may include, but are not limited to, supervised learning, unsupervised learning, semi-supervised learning, reinforcement learning, dimensionality reduction, self-learning, feature learning, sparse dictionary learning, and anomaly detection.

In some examples, the white balance component 202 and demosaic component 206 are also included in the restoration model 208.

The restored scene image data 220 is further processed by the post-model processing stage 218. The post-model processing stage 218 includes a de-flicker component 210 that reduces temporal variations in brightness or color that may be present in a sequence of scene images of the restored scene image data 220. For example, the de-flicker component 210 analyzes the sequence of scene images of the restored scene image data 220 to identify areas of the scene images that exhibit flickering and then applies corrections to reduce the variation over time such as by temporal smoothing, frame averaging, or the like, to reduce the effects of flicker.

The post-model processing stage 218 further includes a sharpness component 214 that sharpens the scene images of the restored scene image data 220. In some examples, the sharpness component 214 uses an Unsharp Masking (USM) technique of creating a blurred copy of a scene image of the restored scene image data 220, subtracting the blurred copy from the original scene image to create a high-pass filtered scene image, and then adding the high-pass filtered scene image back to the original scene image to enhance edges and details of the scene image. In some examples, the sharpness component 214 uses high pass filtering by applying a high-pass filter to a scene image of the restored scene image data 220, which highlights the edges and details in the scene image. The filtered scene image is added back to the original scene image to enhance the edges and details. In some examples, the sharpness component 214 employs frequency domain filtering by converting a scene image of the restored scene image data 220 image to the frequency domain using a Fourier transform, applying a high-pass filter to the frequency domain scene image to enhance the edges and details, and then converting the filtered scene image back to the spatial domain. In some examples, the sharpness component 214 applies edge enhancement filters such as, but not limited to, a Laplacian filter, a Sobel filter, a Prewitt filter, and the like, to scene images of the restored scene image data 220 that are used to enhance the edges in the scene images.

The post-model processing stage 218 further includes a brightness and color adjustment component 212 that adjusts the brightness and color of the scene images in the restored scene image data 220 by adjusting image parameters such as, but not limited to, color balance, brightness, contrast, saturation, hue, and the like, of the scene images.

In some examples, the functions of the brightness and color adjustment component 212 and sharpness component 214 are also included in the restoration model 208.

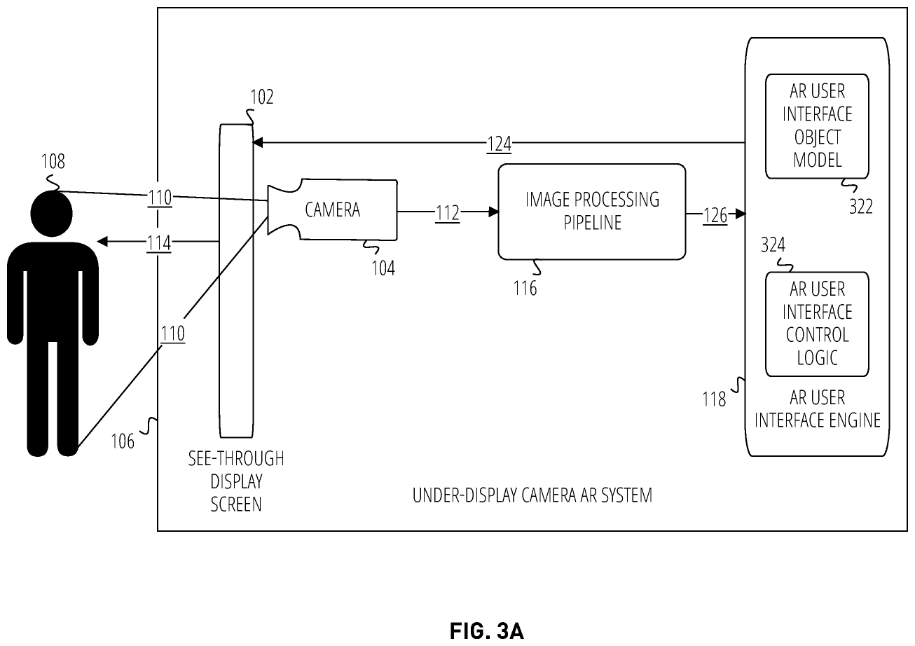

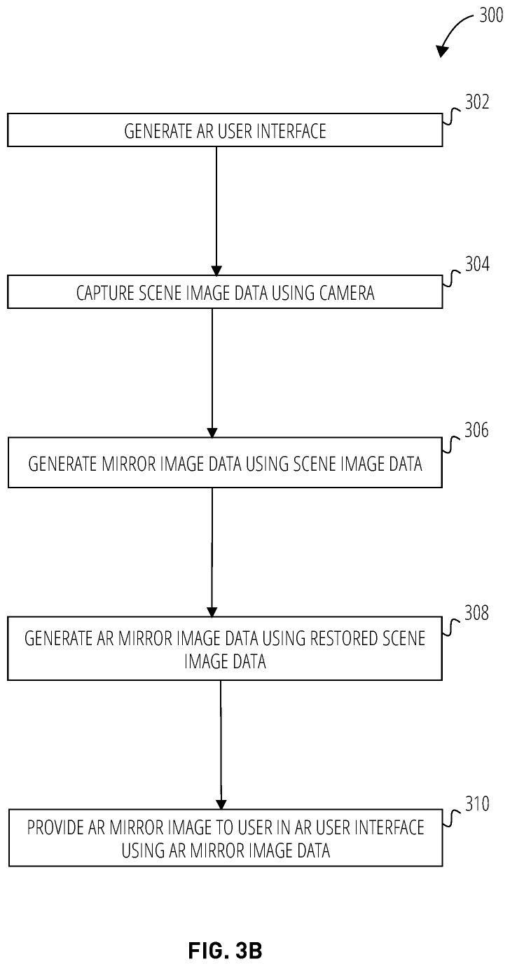

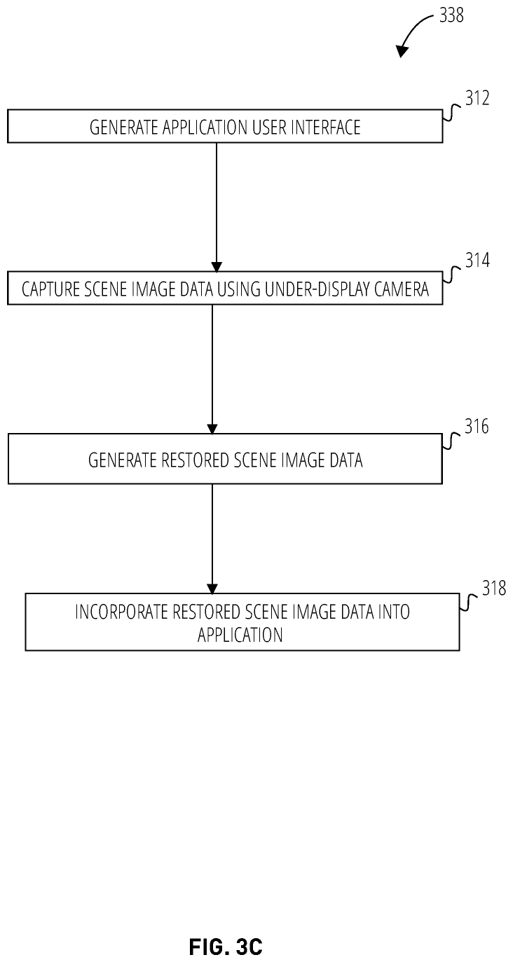

FIG. 3A is a collaboration diagram of components of an AR system implementing an AR mirror and FIG. 3B is an activity diagram of an AR mirror method, according to some examples.

Although an AR mirror method 300 of FIG. 3B depicts a particular sequence of operations, the sequence may be altered without departing from the scope of the present disclosure. For example, some of the operations depicted may be performed in parallel, in a different sequence, or by different components of an AR system, without materially affecting the function of the method.

The AR mirror method 300 is used by an under-display camera AR system 106 to provide an AR experience to a user of the AR system by an AR user interface engine 118. An AR experience may include the user 108 virtually trying on items such as, but not limited to, clothing items, jewelry, makeup, and the like.

In operation 302, the under-display camera AR system 106 generates the AR mirror image 114 provided to the user 108. For example, an AR user interface engine 118 includes AR user interface control logic 324 comprising a dialog script or the like that specifies a user interface dialog implemented using the AR mirror image 114. The AR user interface control logic 324 also includes one or more actions that are to be taken by the under-display camera AR system 106 based on detecting various dialog events such as user inputs.

In some examples, a set of virtual objects are overlaid on images of the user 108 as if the user 108 is wearing objects represented by the virtual objects. The AR user interface object model 322 also includes 3D graphics data of the virtual objects. The 3D graphics data are used by the under-display camera AR system 106 to generate the AR mirror image 114 for display to the user 108.

The AR user interface engine 118 generates AR user interface graphics based on the AR user interface object model 322. The AR user interface graphics data include image video data of the set of virtual objects of the AR mirror image 114. The AR user interface engine 118 communicates the AR user interface graphics data to a display screen driver. The display screen driver receives the AR user interface graphics data and controls the see-through display screen 102 to display the AR mirror image 114 using the AR user interface graphics data. The see-through display screen 102 generates visible images of the AR mirror image 114 including a rendered image of the virtual objects and the visible images are provided to the user 108.

In operation 304, the under-display camera AR system 106 captures scene image data 112 using one or more cameras 104 as described more fully in FIG. 1A and FIG. 2.

In operation 306, the under-display camera AR system 106 uses the image processing pipeline 116 to generate corrected real world scene data 126 using the scene image data 112 as described in FIG. 2.

In operation 308, the under-display camera AR system 106 generates AR mirror image data 124 using the corrected real world scene data 126. For example, the AR user interface engine 118 receives the corrected real world scene data 126 and detects the user 108 using the corrected real world scene data 126. For example, the AR user interface engine 118 detects the user 108 from the corrected real world scene data 126 using computer vision methodologies including, but not limited to, Harris corner detection, Shi-Tomasi corner detection, Scale-Invariant Feature Transform (SIFT), Speeded-Up Robust Features (SURF), Features from Accelerated Segment Test (FAST), Oriented FAST and Rotated BRIEF (ORB), and the like.

In some examples, the AR user interface engine 118 detects the user 108 using artificial intelligence methodologies and a user detection model that was previously generated using machine learning methodologies. In some examples, a user detection model includes, but is not limited to, a neural network, a learning vector quantization network, a logistic regression model, a support vector machine, a random decision forest, a naïve Bayes model, a linear discriminant analysis model, and a K-nearest neighbor model. In some examples, machine learning methodologies used to generate the user detection model may include, but are not limited to, supervised learning, unsupervised learning, semi-supervised learning, reinforcement learning, dimensionality reduction, self-learning, feature learning, sparse dictionary learning, and anomaly detection. In some examples, the AR user interface engine 118 uses the user detection model to detect a specified portion of the user 108, such as the user's hands, feet, head, and the like.

The AR user interface engine 118 generates virtual objects using corrected real world scene data 126 and a 3D texture. For example, the AR user interface engine 118 includes an AR user interface object model 322. The AR user interface object model 322 includes geometric data of a set of virtual objects including respective geometric models of the virtual objects. In addition, the AR user interface object model 322 includes textures that can be applied to the geometric models of the virtual objects during rendering of the virtual objects. In some examples, the virtual objects represent physical objects that can be worn by the user, such as clothing, shoes, rings, watches, and the like. The textured virtual objects are rendered and displayed to the user 108 as part of the AR mirror image 114 during an AR experience such that it appears the user 108 is wearing the virtual object.

In operation 310, the AR user interface engine 118 of the under-display camera AR system 106 displays the AR mirror image 114 to the user in the AR user interface within a context of an AR experience using the AR mirror image data 124.

In some examples, the under-display camera AR system 106 performs the functions of the image processing pipeline 116, the AR user interface engine 118 utilizing various APIs and system libraries of the under-display camera AR system 106.

FIG. 3C is an activity diagram of an under-display camera method 338, in accordance with some examples.

Although an under-display camera method 338 of FIG. 3C depicts a particular sequence of operations, the sequence may be altered without departing from the scope of the present disclosure. For example, some of the operations depicted may be performed in parallel, in a different sequence, or by different components of an under-display camera system, such as under-display camera system 164 of FIG. 1B, without materially affecting the function of the method.

The under-display camera method 338 is used by an under-display camera system 164 to provide corrected real-world scene image data 126 to application 162.

In operation 312, the under-display camera system 164 generates an application image data 166 that is presented to a user 108 (of FIG. 1B). For example, an application 162 (of FIG. 1B) can be any kind of application that both provides image data to a user and also uses image data of the user as previously described. The application generates the application image data 166 and communicates the application image data 166 to a display screen driver. The display screen driver receives the application image data 166 and controls the see-through display screen 102 (of FIG. 1B) to display the application image data 166. The see-through display screen 102 generates visible images of the application image data 166.

In operation 314, the under-display camera system 164 captures scene image data 112 (of FIG. 1B) using one or more cameras 104 (of FIG. 1B) as described more fully in reference to FIG. 1A and FIG. 2.

In operation 316, the under-display camera system 164 uses an image processing pipeline 116 (of FIG. 1B) to generate corrected real-world scene image data 126 (of FIG. 1B) using the scene image data 112 as more fully described in reference to FIG. 2.

In operation 318, the application 162 incorporates the corrected real-world scene image data 126 into within the context of the operations and processes of the application 162.

In some examples, the under-display camera system 164 performs the functions of the image processing pipeline 116 and the application 162 utilizing various APIs and system libraries of the under-display camera system 164.

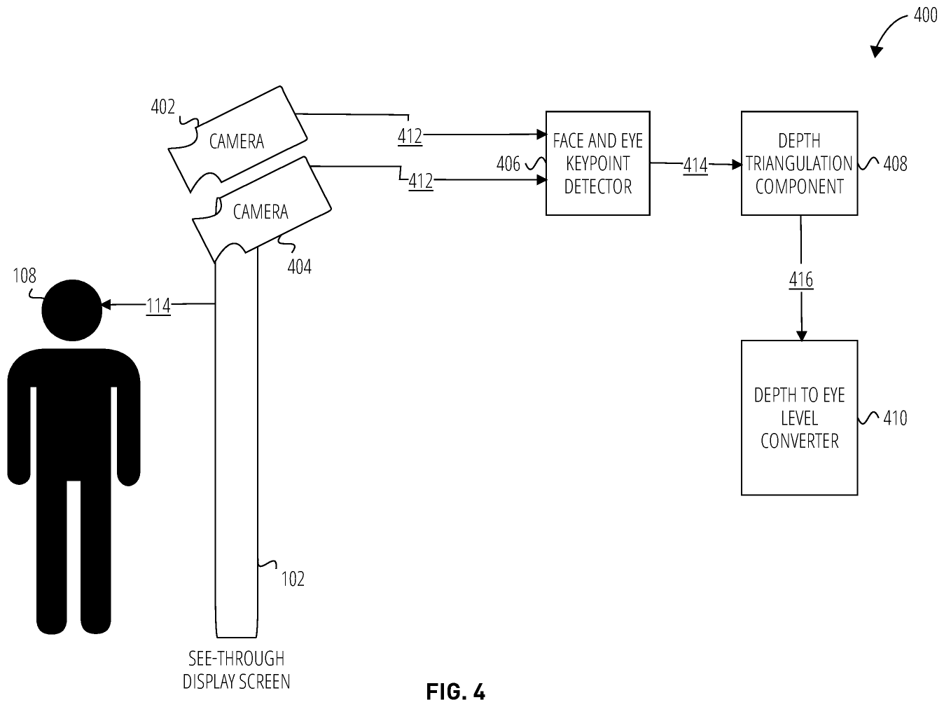

FIG. 4 is an illustration of an eye level detection system, according to some examples. An under-display camera AR system 106 (of FIG. 1A) uses an eye level detection system 400 to determine an eye level of a user 108 in order to provide an AR mirror image displayed such that the eyes of the user 108 align with the eyes of the AR mirror image of the user 108. The eye level detection system 400 includes two or more spaced apart cameras, such as first camera 402 and a second camera 404, that are positioned outside of a see-through display screen 102 of the under-display camera AR system 106. The under-display camera AR system 106 uses the two or more cameras as user-reference cameras to capture user image data 412 of the user 108 as the user 108 uses the under-display camera AR system 106. The under-display camera AR system 106 uses a face and eye keypoint detector 406 to detect keypoints on the face of the user 108 such as, but not limited to, the eyes of the user 108, using the user image data 412. The under-display camera AR system 106 uses a depth triangulation component 408 to determine distance or depth data 416 of the keypoints of the keypoint data 414 from the two or more cameras. The under-display camera AR system 106 uses a depth to eye level converter 410 to determine an eye level of the user 108 using the depth data 416. Referring to FIG. 3B, the under-display camera AR system 106 uses the eye level of the user 108 to automatically adjust a position of an AR mirror image 114 being displayed to the user 108 when generating AR mirror image data in operation 308.

In some examples, the under-display camera AR system 106 uses the user image data 412 to estimate a height of the user 108 and estimates the eye level of the user 108 based on the estimated height of the user 108.

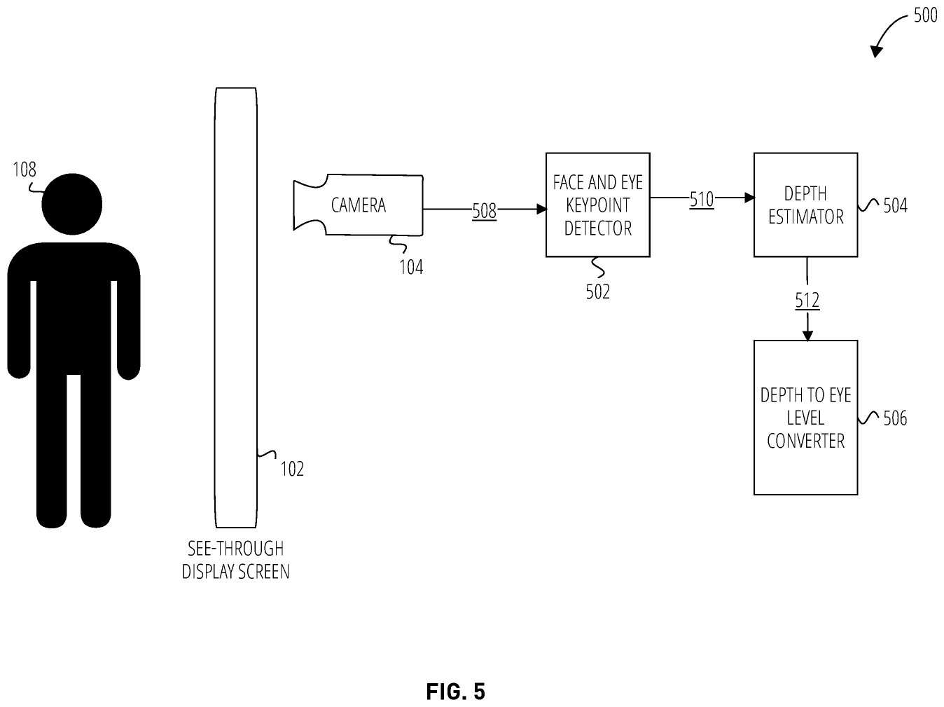

FIG. 5 is an illustration of an eye level detection system, according to some examples. An under-display camera AR system 106 (of FIG. 1A) uses an eye level detection system 400 to determine an eye level of a user 108 in order to provide an AR mirror image displayed such that the eyes of the user 108 align with the eyes of the AR mirror image of the user 108. The eye level detection system 500 utilizes one or more cameras 104 of the under-display camera AR system 106 that are positioned behind the see-through display screen 102. The under-display camera AR system 106 uses the one or more cameras as user-reference cameras to capture user image data 508 of the user 108 as the user 108 uses the under-display camera AR system 106. The under-display camera AR system 106 uses a face and eye keypoint detector 502 to detect keypoints on the face of the user 108 such as, but not limited to, the eyes of the user 108, using the user image data 508. The under-display camera AR system 106 uses a depth estimator 504 to determine distance or depth data 512 of the keypoints of the keypoint data 510 from the one or more user-reference cameras. The under-display camera AR system 106 uses a depth to eye level converter 506 to determine an eye level of the user 108 using the depth data 512. Referring to FIG. 3B, the under-display camera AR system 106 uses the eye level of the user 108 to adjust a position of an AR mirror image 114 being displayed to the user 108 when generating AR mirror image data in operation 308.

In some examples, the eye level detection system 500 includes one or more cameras positioned outside of the see-through display screen 102 and the under-display camera AR system 106 uses the one or more cameras as one or more user-reference cameras to capture the user image data 508.

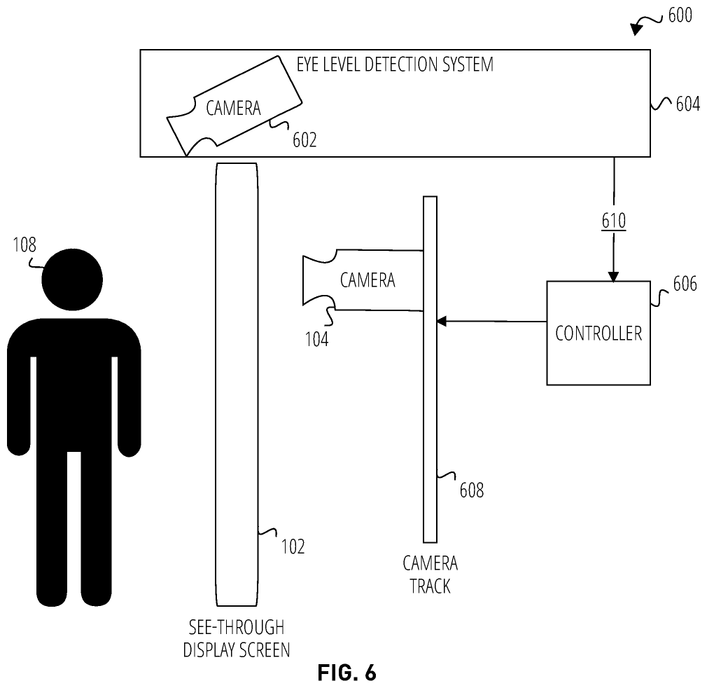

FIG. 6 is an illustration of a camera height adjustment system, according to some examples. An under-display camera AR system 106 (of FIG. 1A) uses a camera level adjustment system 600 to set a height of one or more cameras 104 at an eye level of the user 108. The camera level adjustment system 600 includes an eye level detection system 604, such as eye level detection system 400, eye level detection system 500, and the like, having one or more cameras 602 that the eye level detection system 604 uses to generate eye level data 610 of the user 108 as described in FIG. 4 and FIG. 5. The under-display camera AR system 106 uses a controller 606 to control a camera track 608 that sets a camera height of the one or more cameras 104. The controller 606 receives the eye level data 610 and controls the camera track 608 to automatically position the one or more cameras 104 at the eye level of the user 108.

In some examples, the controller 606 and camera track 608 are operable to automatically position the one or more cameras 104 in a vertical axis. In some examples, the controller 606 and camera track 608 are operable to automatically position the one or more cameras 104 along a horizontal axis. In some examples, the controller 606 and camera track 608 are operable to adjust a pitch or tilt angle of the one or more cameras 104. In some examples, the controller 606 and camera track 608 are operable to adjust a yaw angle of the one or more cameras 104.

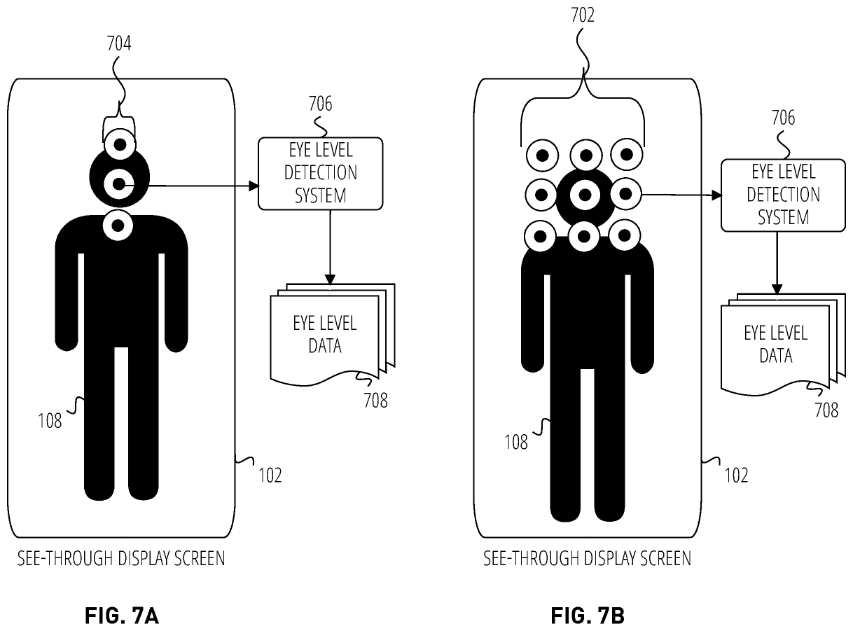

FIG. 7A and FIG. 7B illustrate multi-camera configurations of an AR system, according to some examples. In a multi-camera configuration, an under-display camera AR system 106 (of FIG. 1A) selects one or more cameras in a camera array to use as the one or more cameras 104 (of FIG. 1A) for generating scene image data 112 (of FIG. 1A). The under-display camera AR system 106 uses an eye level detection system 706, such as eye level detection system 500, camera level adjustment system 600, or the like, having as one or more user-reference cameras a camera array, such as vertical camera array 704, camera grid array 702, or the like. The under-display camera AR system 106 uses the eye level detection system 706 to determine eye level data 708 of the user 108 as described in reference to FIG. 5 or FIG. 6. The under-display camera AR system 106 selects one or more cameras of the camera array to use as the one or more cameras 104 of the AR system during an AR experience using the eye level data 708.

In some examples, the under-display camera AR system 106 selects a camera of the camera array that is closest to an eye level or eye position of the user 108 to capture the scene image data 112 (of FIG. 1A).

In some examples, the under-display camera AR system 106 selects two or more user-reference cameras from the camera array. The under-display camera AR system 106 performs an image restoration process as described in FIG. 2 for scene image data captured from the two or more user-reference cameras and performs an interpolation process between the restored image data of the two or more user-reference cameras to generate the restored scene image data 220 (of FIG. 2). In some examples, the under-display camera AR system 106 selects two cameras from the vertical camera array 704 that are closest to an eye level of the user 108. In some examples, the under-display camera AR system 106 selects four cameras from the camera grid array 702 that are closest to an eye level of the user 108.

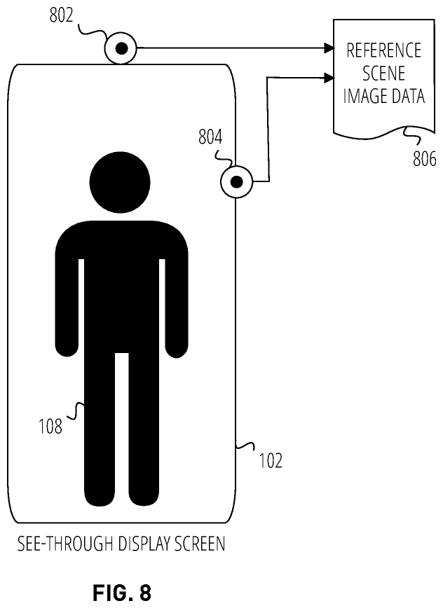

FIG. 8 is an illustration of reference cameras used by an under-display camera system, according to some examples. An under-display camera AR system 106 (of FIG. 1A) or an under-display camera system 164 (of FIG. 1B) uses one or more reference cameras such as, but not limited to, upper reference camera 802, side reference camera 804, or the like, to collect reference scene image data 806 that is synchronized with the one or more cameras 104 (of FIG. 1A) that the under-display camera system uses to generate restored scene image data. The one or more reference cameras are positioned so that they capture scene image data without the light of the scene passing through the see-through display screen 102. The under-display camera uses the reference scene image data 806 to generate corrected real world scene data 126 as described in FIG. 2. For example, as the scene-reference cameras collect the reference scene image data 806 while having a view of the scene that is not obstructed by the see-through display screen 102, the reference scene image data 806 does not contain artifacts introduced by the see-through display screen 102. Accordingly, components of the image processing pipeline 116 can use the reference scene image data 806 as reference data to adjust a parameter of the corrected real world scene data 126 so that it more accurately reflects the lighting parameters of the scene being captured by the camera 104 such as by providing a prior image estimation when a single image restoration process generates an ambiguous result.

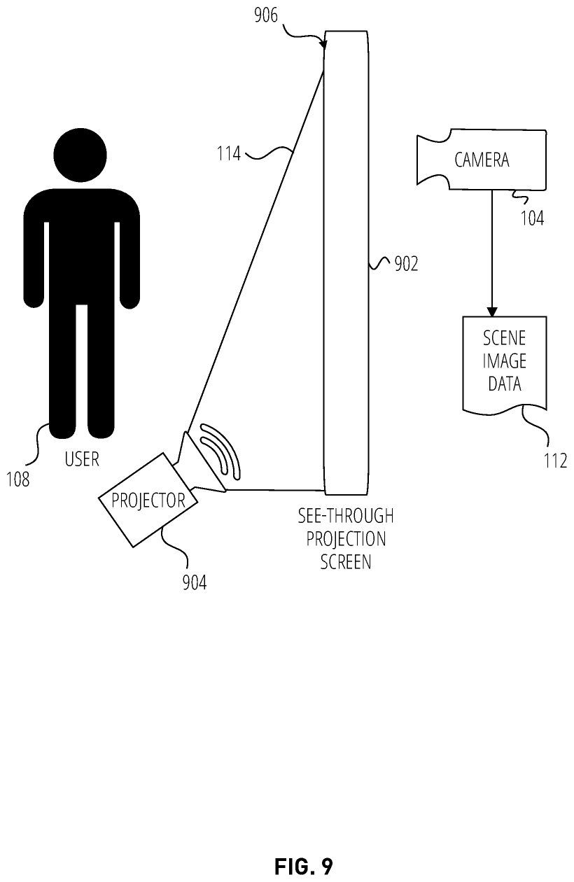

FIG. 9 is a diagram of a see-through projection screen, in accordance with some examples. In some examples, an under-display camera AR system 106 (of FIG. 1A) implementing an AR mirror or an under-display camera system 164 (of FIG. 1B) includes a see-through projection screen 902. The see-through projection screen 902 includes a transparent substrate, such as acrylic, glass, and the like, that is overlaid with a transparent projection film 906 that appears transparent to a user 108. In some examples, the transparent projection film 906 includes nano-particles embedded in a transparent elastic substrate such as, but not limited to, vinyl or the like, that scatter light. One or more projectors 904 project an AR mirror image 114 (of FIG. 1A) onto the transparent projection film 906. One or more cameras 104 (of FIG. 1A) positioned on a side of the see-through projection screen 902 opposite the transparent projection film 906 captures scene image data 112 (of FIG. 1A) that is used to generate the AR mirror image 114 as described herein.

In some examples, the one or more projectors 904 and the one or more cameras 104 are synchronized and they work in an interleaving way. For example, the one or more cameras 104 and the one or more projectors 904 operate at 120 Hz, but in opposite phase where, when the one or more projectors project the AR mirror image 114, the one or more cameras 104 do not capture scene image data 112, and when the one or more projectors do not project the AR mirror image 114, the one or more cameras 104 capture scene image data 112.

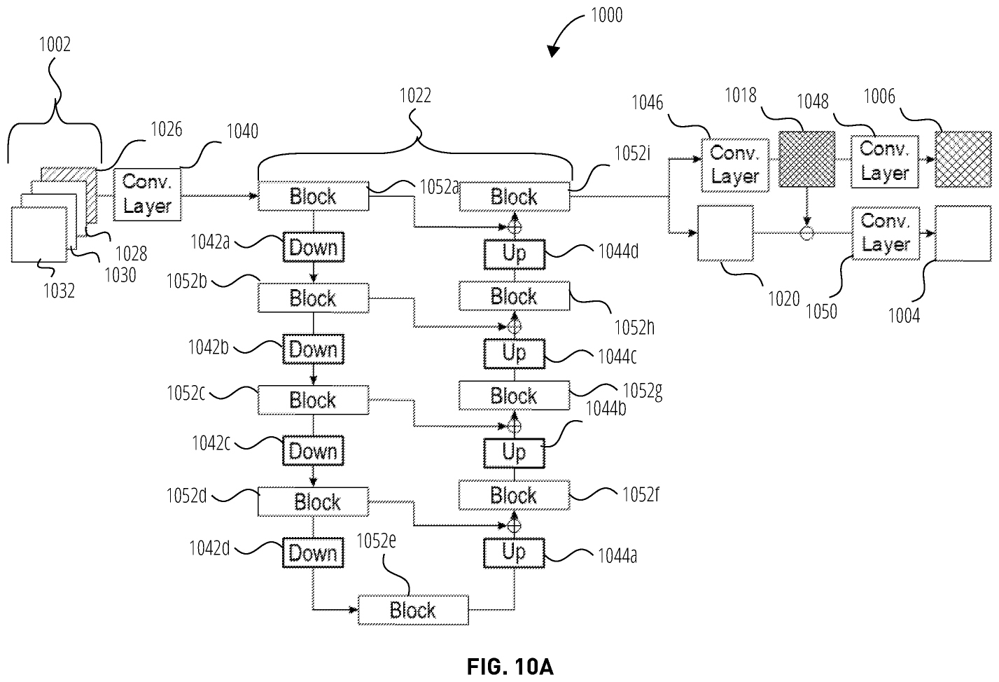

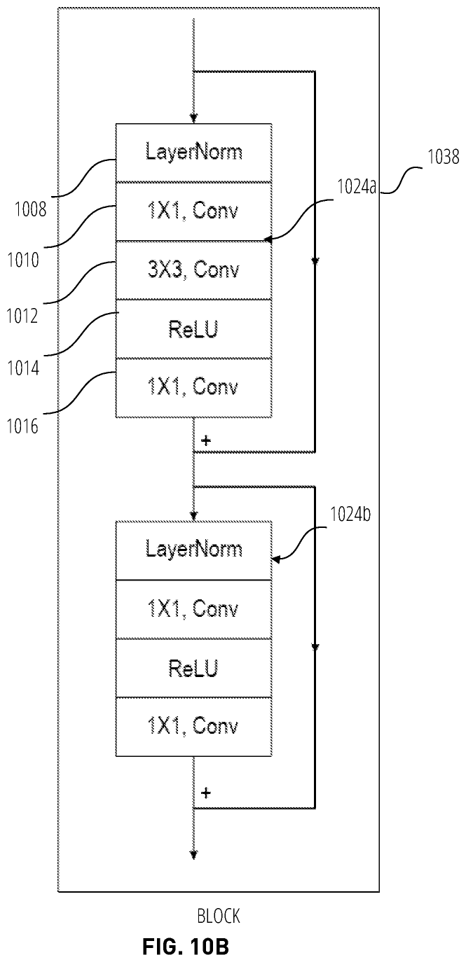

FIG. 10A is a diagram of an encoder-decoder network of a restoration model, and FIG. 10B is a diagram of a block of the encoder-decoder network, according to some examples. An under-display camera AR system 106 (of FIG. 1A) or an under-display camera system 164 (of FIG. 1B) uses a restoration model 208 (of FIG. 2) to generate restored scene image data 220 (of FIG. 2) using scene image data 112 (of FIG. 2). In some examples, an encoder-decoder network 1000 of the restoration model 208 accepts as an input an input tensor 1002 comprising an input scene image 1032 of the scene image data 112, a backscatter mask 1026 of the scene image data 112, a previously restored image 1028, and a previous unrestored scene image 1030. The current scene image is a scene image that is to be processed by the encoder-decoder network 1000.

The encoder-decoder network 1000 generates an intermediate output comprising a full scene image feature tensor 1020 of extracted features of an input scene image and a backscatter feature tensor 1018 that is used to subtract backscatter from the full scene image feature tensor 1020. The under-display camera system generates a final output restored image 1004 using the full scene image feature tensor 1020 and the backscatter feature tensor 1018. In some examples, the restored image 1004 is used as the previously unrestored scene image 1030 of a next input scene image.

In some examples, the encoder-decoder network 1000 generates a backscatter prediction 1006 using the backscatter feature tensor 1018. The backscatter prediction 1006 may be used to process additional images.

In some examples, an encoder portion of the encoder-decoder network 1000 includes downsample convolutional layers 1042a, 1042b, 1042c, 1042d that perform convolutional and normalization operations using blocks 1052a, 1052b, 1052c, and 1052d. Each downsample convolutional layer reduces the spatial dimensions and increases the number of feature channels. This encodes the input image into a compact representation with hierarchical features. The encoder portion of the encoder-decoder network 1000 outputs a context vector in the form of the full scene image feature tensor containing encoded hierarchical features. This context vector is provided to a decoder portion of the encoder-decoder network 1000. In some examples, a downsample convolutional layer includes a 2×2 convolutional layer with a stride of 2.

In some examples, a decoder portion of the encoder-decoder network 1000 includes upsample convolutional layers 1044a, 1044b, 1044c, 1044d that reconstruct the spatial dimensions back to the original input size using blocks 1052e, 1052f, 1052g, 1052h, and 1052i. In some examples, an upsample convolutional layer first uses lxi convolution and pixel shuffle to upsample spatially. Then features are combined across channels using the blocks. The decoder generates the restored image 1004 which matches the original input spatial dimensions. This output restored image is used for further processing in the image pipeline.

In some examples, a convolutional layer 1040 performs convolutional and normalization operations on the input scene image 1032 from the input tensor 1002 to produce feature maps with smaller spatial dimension and higher feature dimension. This encodes the input image into a compact representation with hierarchical features used as input for the encoder portion of the encoder-decoder network 1000.

In some examples, a convolutional layer 1046 performs convolutional operations on an upsampled feature map from the decoder portion of the encoder-decoder network 1000 to generate the backscatter feature tensor 1018.

In some examples, convolutional layer 1048 performs convolutional operations on the backscatter feature tensor 1018 to generate the backscatter prediction 1006.

In some examples, a convolutional layer 1050 takes as input the full scene image feature tensor 1020 after it has been processed with the backscatter feature tensor 1018 to remove backscatter features. The full scene image feature tensor 1020 contains extracted features of the input scene image. The convolutional layer 1050 then performs convolutional operations on this full set of image features with backscatter removed. By performing these convolutional operations, the convolutional layer 1050 reconstructs the final restored image 1004 from the full scene image feature tensor 1020. In summary, the convolutional layer 1050 generates the final restored image 1004 by performing convolutional operations on the full scene image feature tensor 1020 after backscatter has been removed.

Referring to FIG. 10B, a block 1038 of the encoder-decoder network, such as one or more of blocks 1022, includes two or more sub-blocks, such as sub-block 1024a and sub-block 1024b. Each sub-block includes a normalization layer 1008, a 1 pixel by 1 pixel convolution layer 1010, a 3 pixel by 3 pixel convolution layer 1012, a rectified linear unit layer 1014, and a 1 pixel by 1 pixel convolution layer 1016.

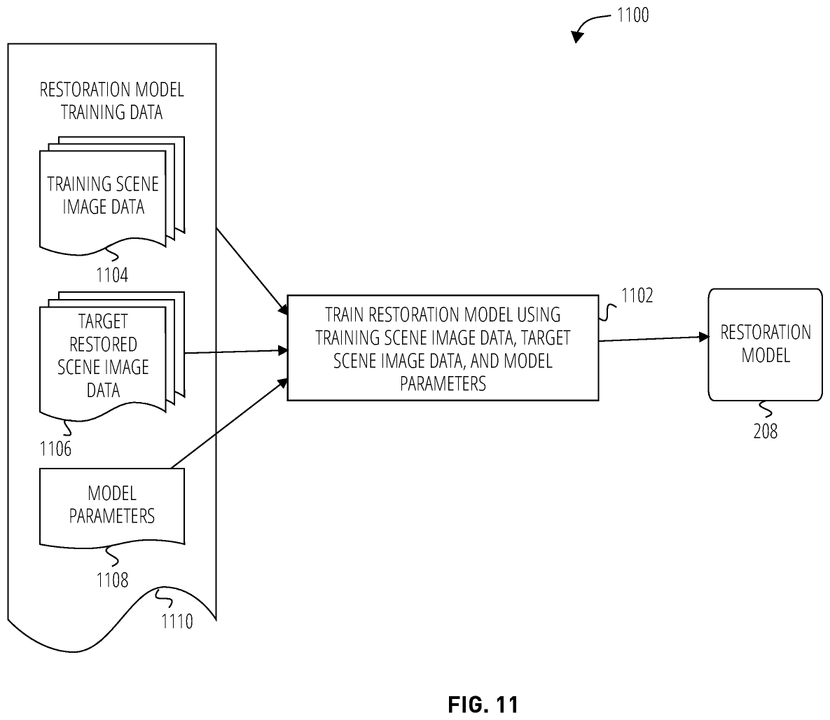

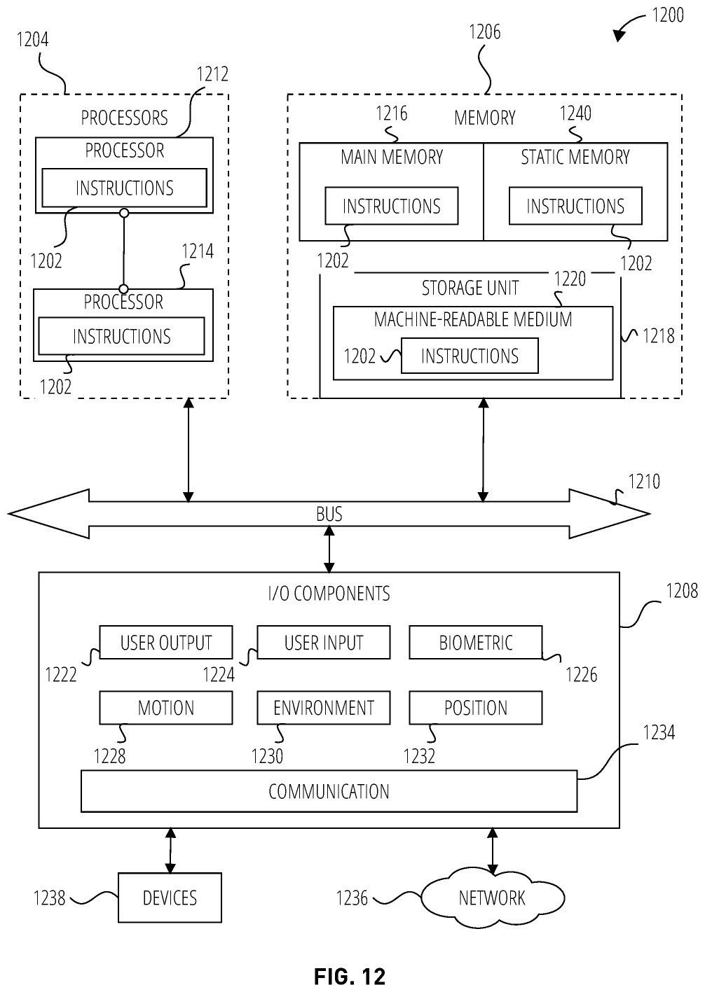

FIG. 11 is process flow diagram of a restoration model training method, according to some examples. A restoration model training system, such as machine 1200 (of FIG. 12) uses a restoration model training method 1100 to train a restoration model 208. In operation 1102, the restoration model training system uses restoration model training data 1110 to train the restoration model 208. For example, the restoration model training data 1110 includes training scene image data 1104. In some examples, the training scene image data 1104 is collected from an AR system during a calibration phase using calibrated parameters.

In some examples, the training scene image data 1104 is synthesized data generated by introducing artifacts and noise into a scene image data captured without a see-through display screen obscuring a camera. Synthetic data are artificially created images that simulate the types of degradation that would be observed when a camera captures images through a display screen, such as the wiring effect, noise, and backscatter. In some examples, a model of the entire image formation pipeline is created. By understanding the equations that describe how images are formed and degraded by the display, large dataset of simulated degraded images and their corresponding high-quality ground truth images can be created. This simulated dataset can then be used in a supervised training method for the neural network, where the network learns to restore the degraded images to their original, undistorted state. The synthetic data approach is an alternative to capturing a real dataset, which can be challenging because of the difficulty in obtaining ground truth images when a display is in front of the camera. By simulating the data, the images displayed and the types of degradation applied can be controlled, creating a comprehensive set of training examples for the neural network without the need for complex physical setups.

For example, a mathematical model that accurately represents the image formation process for an under-display camera is developed. This model includes variables and functions designed to simulate various degradation effects, such as the display's point spread function, spatial aperture modulation (wiring mask), backscatter effects, and noise characteristics.

A large number of degraded images are generated from high-quality originals, which are used as the ground truth. The degradation process involves the application of a spatially-varying blur to represent the point spread function, the addition of patterns to simulate the wiring effect, the introduction of noise to mimic sensor and environmental interference, and the overlaying of backscatter effects based on the displayed content and its interaction with the camera optics.

Pairs of original and degraded images are created for each high-quality image. These pairs provide training examples for supervised learning, offering the machine learning model both the input (degraded image) and the desired output (restored image).

The paired images are compiled into a structured dataset for the purpose of training a machine learning model used as a restoration model. A wide range of scenes, content types, and degradation levels are included in the dataset to ensure that the machine learning model can effectively generalize when restoring images from the real world.

The synthetic dataset is utilized to train the machine learning model, which is taught to map degraded images back to their high-quality versions. The machine learning model's weights and biases are adjusted to reduce the difference between the machine learning model's output and the ground truth, thereby enhancing the machine learning model's performance in image restoration.

In some examples, the process of generating a training dataset involves the display of various images on a monitor, which are then simultaneously captured by an under-display camera. This method allows for the displayed images to serve as ground truth for the training of a restoration model. The restoration model is trained to recognize and correct the degradation in the captured images by comparing them to the known, undistorted images displayed on the monitor. Accordingly, a training dataset including pairs of ground truth images and degraded images are generated.

In some examples, the restoration model training data 1110 further includes target restored scene image data 1106 and model parameters 1108.

The training scene image data 1104 and the target restored scene image data 1106 provide tuples of captured scene images as pre-processed by a pre-model processing stage 216 (of FIG. 2) of an image processing pipeline 116 (of FIG. 2) and restored scene images. The restoration model training data 1110 further includes model parameters 1108 of the restoration model 208. The tuples of captured scene images and restored scene images, and the model parameters 1108, are used by the restoration model training system to train the restoration model 208. The model parameters 1108 comprise parameters or coefficients of the restoration model 208. During training, the model parameters 1108 are adapted using input-output training pairings of the tuples. After the model parameters 1108 are adapted (after training), the model parameters 1108 are used by the restoration model 208 to generate restored scene image data 220 (of FIG. 2) using pre-processed scene image data 222 (of FIG. 2) captured by an under-display camera system such as, but not limited to, under-display camera AR system 106 (of FIG. 1A) during an AR session, or under-display camera system 164 (of FIG. 1B).

The restoration model training system generates a restoration model 208 using the training scene image data 1104 and the target restored scene image data 1106. For example, the restoration model training system trains the restoration model 208 based on one or more machine learning techniques using the tuples of paired captured and pre-processed scene images and restored scene images. For example, the restoration model training system may train the model parameters 1108 by minimizing a loss function using the ground-truth of the target restored scene image data 1106. For example, the loss function may use the sets of restored scene images of the target restored scene image data 1106 as the ground truth training data.

The restoration model 208 can include any one or a combination of classifiers or neural networks, such as an artificial neural network, an encoder-decoder network, a convolutional neural network, an adversarial network, a generative adversarial network, a deep feed forward network, a radial basis network, a recurrent neural network, a long/short term memory network, a gated recurrent unit, an auto encoder, a variational autoencoder, a denoising autoencoder, a sparse autoencoder, a Markov chain, a Hopfield network, a Boltzmann machine, a restricted Boltzmann machine, a deep belief network, a deep convolutional network, a deconvolutional network, a deep convolutional inverse graphics network, a liquid state machine, an extreme learning machine, an echo state network, a deep residual network, a Kohonen network, a support vector machine, a neural Turing machine, and the like.

In some examples, a derivative of a loss function is computed based on a comparison of a set of estimated restored scene images generated from the training scene image data 1104 and the ground truth of a set of paired target restored scene images of the target restored scene image data 1106. The model parameters 1108 of the restoration model 208 are updated using the computed derivative of the loss function.

The result of minimizing the loss function for multiple sets of training scene image data 1104 and target restored scene image data 1106 trains, adapts, or optimizes the model parameters 1108 of the restoration model 208. In this way, the restoration model 208 is trained to establish a relationship between pre-processed scene image data 222 generated from scene image data 112 and restored scene image data 220 as more fully described in FIG. 2.

### Machine Architecture

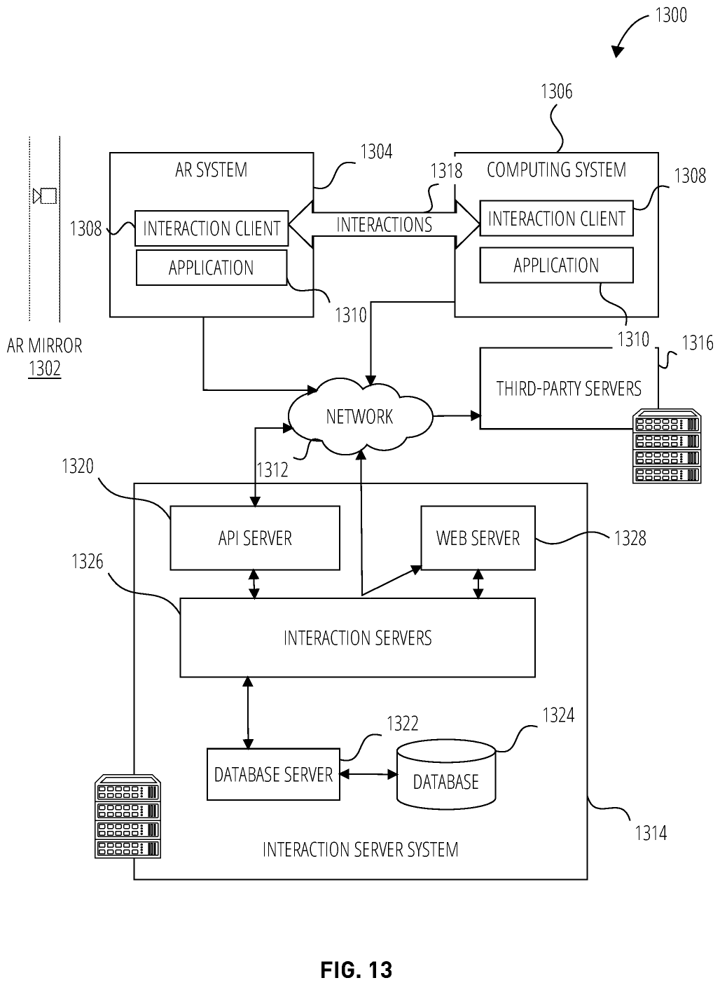

FIG. 12 is a diagrammatic representation of the machine 1200 within which instructions 1202 (e.g., software, a program, an application, an applet, an app, or other executable code) for causing the machine 1200 to perform any one or more of the methodologies of a head-wearable apparatus or mobile device as discussed herein may be executed. For example, the instructions 1202 may cause the machine 1200 to execute any one or more of the methods described herein. The instructions 1202 transform the general, non-programmed machine 1200 into a particular machine 1200 programmed to carry out the described and illustrated functions in the manner described. The machine 1200 may operate as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1202, sequentially or otherwise, that specify actions to be taken by the machine 1200. Further, while a single machine 1200 is illustrated, the term “machine” shall also be taken to include a collection of machines that individually or jointly execute the instructions 1202 to perform any one or more of the methodologies discussed herein. The machine 1200, for example, may comprise the under-display camera AR system 106 (of FIG. 1A), under-display camera system 164 (of FIG. 1B), AR system 1304 (of FIG. 13) or any one of multiple server devices forming part of the interaction server system 1314. In some examples, the machine 1200 may also comprise both client and server systems, with certain operations of a particular method or algorithm being performed on the server-side and with certain operations of the particular method or algorithm being performed on the client-side.

The machine 1200 may include processors 1204, memory 1206, and input/output I/O components 1208, which may be configured to communicate with each other via a bus 1210. In an example, the processors 1204 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1212 and a processor 1214 that execute the instructions 1202. The term “processor” is intended to include multi-core processors that may comprise two or more independent processors (sometimes referred to as “cores”) that may execute instructions contemporaneously. Although FIG. 12 shows multiple processors 1204, the machine 1200 may include a single processor with a single core, a single processor with multiple cores (e.g., a multi-core processor), multiple processors with a single core, multiple processors with multiples cores, or any combination thereof.

The memory 1206 includes a main memory 1216, a static memory 1240, and a storage unit 1218, both accessible to the processors 1204 via the bus 1210. The main memory 1206, the static memory 1240, and storage unit 1218 store the instructions 1202 embodying any one or more of the methodologies or functions described herein. The instructions 1202 may also reside, completely or partially, within the main memory 1216, within the static memory 1240, within machine-readable medium 1220 within the storage unit 1218, within at least one of the processors 1204 (e.g., within the processor's cache memory), or any suitable combination thereof, during execution thereof by the machine 1200.

The I/O components 1208 may include a wide variety of components to receive input, provide output, produce output, transmit information, exchange information, capture measurements, and so on. The specific I/O components 1208 that are included in a particular machine will depend on the type of machine. For example, portable machines such as mobile phones may include a touch input device or other such input mechanisms, while a headless server machine will likely not include such a touch input device. It will be appreciated that the I/O components 1208 may include many other components that are not shown in FIG. 12. In various examples, the I/O components 1208 may include user output components 1222 and user input components 1224. The user output components 1222 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1224 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1208 may include biometric components 1226, motion components 1228, environmental components 1230, or position components 1232, among a wide array of other components. For example, the biometric components 1226 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1228 include acceleration sensor components (e.g., accelerometer), gravitation sensor components, rotation sensor components (e.g., gyroscope), and the like. In some examples, the position sensors may be incorporated in an Inertial Motion Unit (IMU) or the like.

The environmental components 1230 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), depth or distance sensors (e.g., sensors to determine a distance to an object or a depth in a 3D coordinate system of features of an object), or other components that may provide indications, measurements, or signals corresponding to a surrounding physical environment.

Communication may be implemented using a wide variety of technologies. The I/O components 1208 further include communication components 1234 operable to couple the machine 1200 to a network 1236 or devices 1238 via respective coupling or connections. For example, the communication components 1234 may include a network interface component or another suitable device to interface with the network 1236. In further examples, the communication components 1234 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1238 may be another machine or any of a wide variety of peripheral devices (e.g., a peripheral device coupled via a USB).

Moreover, the communication components 1234 may detect identifiers or include components operable to detect identifiers. For example, the communication components 1234 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1234, such as location via Internet Protocol (IP) geolocation, location via Wi-Fi® signal triangulation, location via detecting an NFC beacon signal that may indicate a particular location, and so forth.

The various memories (e.g., main memory 1216, static memory 1240, and memory of the processors 1204) and storage unit 1218 may store one or more sets of instructions and data structures (e.g., software) embodying or used by any one or more of the methodologies or functions described herein. These instructions (e.g., the instructions 1202), when executed by processors 1204, cause various operations to implement the disclosed examples.

The instructions 1202 may be transmitted or received over the network 1236, using a transmission medium, via a network interface device (e.g., a network interface component included in the communication components 1234) and using any one of several well-known transfer protocols (e.g., hypertext transfer protocol (HTTP)). Similarly, the instructions 1202 may be transmitted or received using a transmission medium via a coupling (e.g., a peer-to-peer coupling) to the devices 1238.

### Networked Computing Environment

FIG. 13 is a block diagram showing an example interaction system 1300 for facilitating interactions (e.g., exchanging text messages, conducting text audio and video calls, or playing games) over a network. The interaction system 1300 includes one or more AR systems, such as AR system 1304 configured as an AR mirror 1302, each of which hosts multiple applications, including an interaction client 1308 and other applications 1310. Each interaction client 1308 is communicatively coupled, via one or more communication networks including a network 1312 (e.g., the Internet), to other instances of the interaction client 1308 (e.g., hosted on respective other computing systems such as computing system 1306), an interaction server system 1314 and third-party servers 1316). An interaction client 1308 can also communicate with locally hosted applications 1310 using Applications Program Interfaces (APIs).

An interaction client 1308 interacts with other interaction clients 1308 and with the interaction server system 1314 via the network 1312. The data exchanged between the interaction clients 1308 (e.g., interactions 1318) and between the interaction clients 1308 and the interaction server system 1314 includes functions (e.g., commands to invoke functions) and payload data (e.g., text, audio, video, or other multimedia data).

The interaction server system 1314 provides server-side functionality via the network 1312 to the interaction clients 1308. While certain functions of the interaction system 1300 are described herein as being performed by either an interaction client 1308 or by the interaction server system 1314, the location of certain functionality either within the interaction client 1308 or the interaction server system 1314 may be a design choice. For example, it may be technically preferable to initially deploy particular technology and functionality within the interaction server system 1314 but to later migrate this technology and functionality to the interaction client 1308 where an AR system 1304 has sufficient processing capacity.

The interaction server system 1314 supports various services and operations that are provided to the interaction clients 1308. Such operations include transmitting data to, receiving data from, and processing data generated by the interaction clients 1308. This data may include message content, client device information, geolocation information, media augmentation and overlays, message content persistence conditions, entity relationship information, and live event information. Data exchanges within the interaction system 1300 are invoked and controlled through functions available via user interfaces (UIs) of the interaction clients 1308.

Turning now specifically to the interaction server system 1314, an Application Program Interface (API) server 1320 is coupled to and provides programmatic interfaces to Interaction servers 1326, making the functions of the Interaction servers 1326 accessible to interaction clients 1308, other applications 1310 and third-party server 1316. The Interaction servers 1326 are communicatively coupled to a database server 1322, facilitating access to a database 1324 that stores data associated with interactions processed by the Interaction servers 1326. Similarly, a web server 1328 is coupled to the Interaction servers 1326 and provides web-based interfaces to the Interaction servers 1326. To this end, the web server 1328 processes incoming network requests over the Hypertext Transfer Protocol (HTTP) and several other related protocols.

The Application Program Interface (API) server 1320 receives and transmits interaction data (e.g., commands and message payloads) between the interaction servers 1326 and the AR system 1304 (and, for example, interaction clients 1308 and other applications 1310) and the third-party server 1316. Specifically, the Application Program Interface (API) server 1320 provides a set of interfaces (e.g., routines and protocols) that can be called or queried by the interaction client 1308 and other applications 1310 to invoke functionality of the interaction servers 1326. The Application Program Interface (API) server 1320 exposes various functions supported by the interaction servers 1326, including account registration; login functionality; the sending of interaction data, via the interaction servers 1326, from a particular interaction client 1308 to another interaction client 1308; the communication of media files (e.g., images or video) from an interaction client 1308 to the interaction servers 1326; the settings of a collection of media data (e.g., a story); the retrieval of a list of friends of a user of an AR system 1304; the retrieval of messages and content; the addition and deletion of entities (e.g., friends) to an entity graph (e.g., a social graph); the location of friends within a social graph; and opening an application event (e.g., relating to the interaction client 1308).

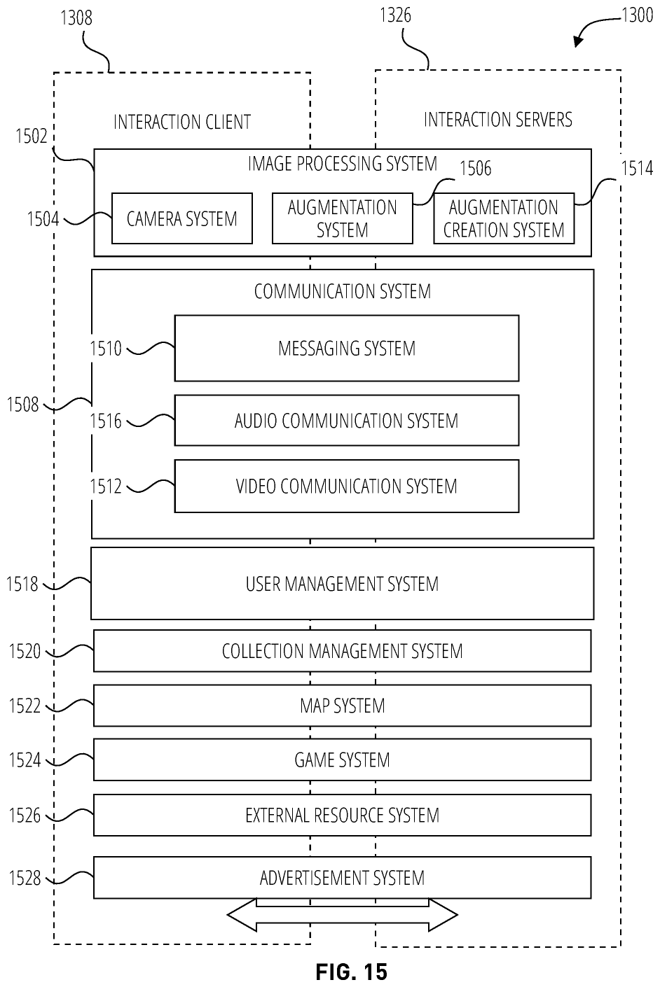

The interaction servers 1326 host multiple systems and subsystems, described below with reference to FIG. 15. Returning to the interaction client 1308, features and functions of an external resource (e.g., a linked application 1310 or applet) are made available to a user via an interface of the interaction client 1308. In this context, “external” refers to the fact that the application 1310 or applet is external to the interaction client 1308. The external resource is often provided by a third party but may also be provided by the creator or provider of the interaction client 1308. The interaction client 1308 receives a user selection of an option to launch or access features of such an external resource. The external resource may be the application 1310 installed on the AR system 1304 (e.g., a “native app”), or a small-scale version of the application (e.g., an “applet”) that is hosted on the AR system 1304 or remote of the AR system 1304 (e.g., on third-party servers 1316). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 1308. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 1308 determines whether the selected external resource is a web-based external resource or a locally installed application 1310. In some cases, applications 1310 that are locally installed on the AR system 1304 can be launched independently of and separately from the interaction client 1308, such as by selecting an icon corresponding to the application 1310 on a home screen of the AR system 1304. Small-scale versions of such applications can be launched or accessed via the interaction client 1308 and, in some examples, no or limited portions of the small-scale application can be accessed outside of the interaction client 1308. The small-scale application can be launched by the interaction client 1308 receiving, from a third-party server 1316 for example, a markup-language document associated with the small-scale application and processing such a document.

In response to determining that the external resource is a locally installed application 1310, the interaction client 1308 instructs the AR system 1304 to launch the external resource by executing locally-stored code corresponding to the external resource. In response to determining that the external resource is a web-based resource, the interaction client 1308 communicates with the third-party servers 1316 (for example) to obtain a markup-language document corresponding to the selected external resource. The interaction client 1308 then processes the obtained markup-language document to present the web-based external resource within a user interface of the interaction client 1308.

The interaction client 1308 can notify a user of the AR system 1304, or other users related to such a user (e.g., “friends”), of activity taking place in one or more external resources. For example, the interaction client 1308 can provide participants in a conversation (e.g., a chat session) in the interaction client 1308 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 1308, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 1308. The external resource can selectively include different media items in the responses, based on a current context of the external resource.

The interaction client 1308 can present a list of the available external resources (e.g., applications 1310 or applets) to a user to launch or access a given external resource. This list can be presented in a context-sensitive menu. For example, the icons representing different ones of the application 1310 (or applets) can vary based on how the menu is launched by the user (e.g., from a conversation interface or from a non-conversation interface).

### Data Architecture

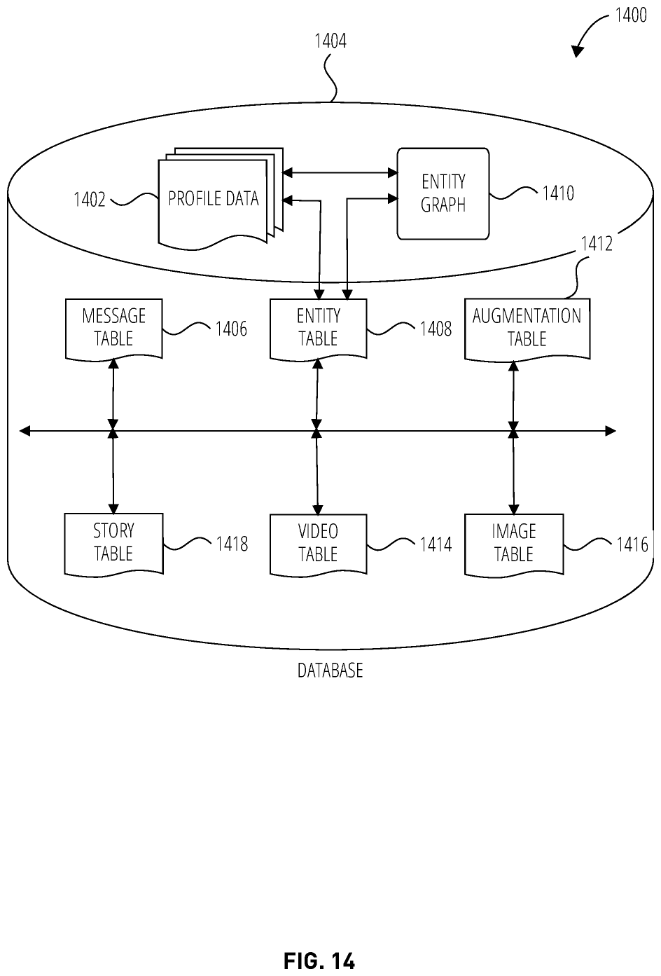

FIG. 14 is a schematic diagram illustrating data structures 1400, which may be stored in the database 1404 of the interaction server system 1314, according to certain examples. While the content of the database 1404 is shown to comprise multiple tables, it will be appreciated that the data could be stored in other types of data structures (e.g., as an object-oriented database).

The database 1404 includes message data stored within a message table 1406. This message data includes, for any particular message, at least message sender data, message recipient (or receiver) data, and a payload. Further details regarding information that may be included in a message, and included within the message data stored in the message table 1406, are described below with reference to FIG. 14.

An entity table 1408 stores entity data, and is linked (e.g., referentially) to an entity graph 1410 and profile data 1402. Entities for which records are maintained within the entity table 1408 may include individuals, corporate entities, organizations, objects, places, events, and so forth. Regardless of entity type, any entity regarding which the interaction server system 1314 stores data may be a recognized entity. Each entity is provided with a unique identifier, as well as an entity type identifier (not shown).

The entity graph 1410 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 1300.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 1408. Such privacy settings may be applied to all types of relationships within the context of the interaction system 1300, or may selectively be applied to only certain types of relationships.

The profile data 1402 stores multiple types of profile data about a particular entity. The profile data 1402 may be selectively used and presented to other users of the interaction system 1300 based on privacy settings specified by a particular entity. Where the entity is an individual, the profile data 1402 includes, for example, a username, telephone number, address, settings (e.g., notification and privacy settings), as well as a user-selected avatar representation (or collection of such avatar representations). A particular user may then selectively include one or more of these avatar representations within the content of messages communicated via the interaction system 1300, and on map interfaces displayed by interaction clients 1308 to other users. The collection of avatar representations may include “status avatars,” which present a graphical representation of a status or activity that the user may select to communicate at a particular time.

Where the entity is a group, the profile data 1402 for the group may similarly include one or more avatar representations associated with the group, in addition to the group name, members, and various settings (e.g., notifications) for the relevant group.

The database 1404 also stores augmentation data, such as overlays or filters, in an augmentation table 1412. The augmentation data is associated with and applied to videos (for which data is stored in a video table 1414) and images (for which data is stored in an image table 1416).

Filters, in some examples, are overlays that are displayed as overlaid on an image or video during presentation to a message receiver. Filters may be of various types, including user-selected filters from a set of filters presented to a message sender by the interaction client 1308 when the message sender is composing a message. Other types of filters include geolocation filters (also known as geo-filters), which may be presented to a message sender based on geographic location. For example, geolocation filters specific to a neighborhood or special location may be presented within a user interface by the interaction client 1308, based on geolocation information determined by a Global Positioning System (GPS) unit of the AR system 1304.

Another type of filter is a data filter, which may be selectively presented to a message sender by the interaction client 1308 based on other inputs or information gathered by the AR system 1304 during the message creation process. Examples of data filters include current temperature at a specific location, a current speed at which a message sender is traveling, battery life for an AR system 1304, or the current time.

Other augmentation data that may be stored within the image table 1416 includes augmented reality content items (e.g., corresponding to applying Lenses or augmented reality experiences). An augmented reality content item may be a real-time special effect and sound that may be added to an image or a video.

As described above, augmentation data includes AR, VR, and mixed reality (MR) content items, overlays, image transformations, images, and modifications that may be applied to image data (e.g., videos or images). This includes real-time modifications, which modify an image as it is captured using device sensors (e.g., one or multiple cameras) of the AR system 1304 and then displayed on a screen of the AR system 1304 with the modifications. This also includes modifications to stored content, such as video clips in a collection or group that may be modified. For example, in an AR system 1304 with access to multiple augmented reality content items, a user can use a single video clip with multiple augmented reality content items to see how the different augmented reality content items will modify the stored clip. Similarly, real-time video capture may use modifications to show how video images currently being captured by sensors of an AR system 1304 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudorandom animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects, and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of an object's elements, characteristic points for each element of an object are calculated (e.g., using an Active Shape Model (ASM) or other known methods). Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification, properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, visual features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

A transformation system can capture an image or video stream on a client device (e.g., the AR system 1304) and perform complex image manipulations locally on the AR system 1304 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the AR system 1304.

In some examples, a computer animation model to transform image data can be used by a system where a user may capture an image or video stream of the user (e.g., a selfie) using the AR system 1304 having a neural network operating as part of an interaction client 1308 operating on the AR system 1304. The transformation system operating within the interaction client 1308 determines the presence of a face within the image or video stream and provides modification icons associated with a computer animation model to transform image data, or the computer animation model can be present as associated with an interface described herein. The modification icons include changes that are the basis for modifying the user's face within the image or video stream as part of the modification operation. Once a modification icon is selected, the transform system initiates a process to convert the image of the user to reflect the selected modification icon (e.g., generate a smiling face on the user). A modified image or video stream may be presented in a graphical user interface displayed on the AR system 1304 as soon as the image or video stream is captured and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

The graphical user interface, presenting the modification performed by the transform system, may supply the user with additional interaction options. Such options may be based on the interface used to initiate the content capture and selection of a particular computer animation model (e.g., initiation from a content creator user interface). In various examples, a modification may be persistent after an initial selection of a modification icon. The user may toggle the modification on or off by tapping or otherwise selecting the face being modified by the transformation system and store it for later viewing or browsing to other areas of the imaging application. Where multiple faces are modified by the transformation system, the user may toggle the modification on or off globally by tapping or selecting a single face modified and displayed within a graphical user interface. In some examples, individual faces, among a group of multiple faces, may be individually modified, or such modifications may be individually toggled by tapping or selecting the individual face or a series of individual faces displayed within the graphical user interface.

A story table 1418 stores data regarding collections of messages and associated image, video, or audio data, which are compiled into a collection (e.g., a story or a gallery). The creation of a particular collection may be initiated by a particular user (e.g., each user for which a record is maintained in the entity table 1408). A user may create a “personal story” in the form of a collection of content that has been created and sent/broadcast by that user. To this end, the user interface of the interaction client 1308 may include an icon that is user-selectable to enable a message sender to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 1308, to contribute content to a particular live story. The live story may be identified to the user by the interaction client 1308, based on his or her location. The end result is a “live story” told from a community perspective.

A further type of content collection is known as a “location story,” which enables a user whose AR system 1304 is located within a specific geographic location (e.g., on a college or university campus) to contribute to a particular collection. In some examples, a contribution to a location story may require a second degree of authentication to verify that the end-user belongs to a specific organization or other entity (e.g., is a student on the university campus).

As mentioned above, the video table 1414 stores video data that, in some examples, is associated with messages for which records are maintained within the message table 1406. Similarly, the image table 1416 stores image data associated with messages for which message data is stored in the entity table 1408. The entity table 1408 may associate various augmentations from the augmentation table 1412 with various images and videos stored in the image table 1416 and the video table 1414.

### System Architecture

FIG. 15 is a block diagram illustrating further details regarding the interaction system 1300, according to some examples. Specifically, the interaction system 1300 is shown to comprise the interaction client 1308 and the interaction servers 1326. The interaction system 1300 embodies multiple subsystems, which are supported on the client-side by the interaction client 1308 and on the server-side by the interaction servers 1326. Example subsystems are discussed below.

An image processing system 1502 provides various functions that enable a user to capture and augment (e.g., augment or otherwise modify or edit) media content associated with a message.

A camera system 1504 includes control software (e.g., in a camera application) that interacts with and controls hardware camera hardware (e.g., directly or via operating system controls) of the AR system 1304 to modify and augment real-time images captured and displayed via the interaction client 1308.

The augmentation system 1506 provides functions related to the generation and publishing of augmentations (e.g., media overlays) for images captured in real-time by cameras of the AR system 1304 or retrieved from memory of the AR system 1304. For example, the augmentation system 1506 operatively selects, presents, and displays media overlays (e.g., an image filter or an image lens) to the interaction client 1308 for the augmentation of real-time images received via the camera system 1504 or stored images retrieved from memory of an AR system 1304. These augmentations are selected by the augmentation system 1506 and presented to a user of an interaction client 1308, based on a number of inputs and data, such as for example:
Geolocation of the AR system 1304; and
Entity relationship information of the user of the AR system 1304.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at AR system 1304 for communication in a message, or applied to video content, such as a video content stream or feed transmitted from an interaction client 1308. As such, the image processing system 1502 may interact with, and support, the various subsystems of the communication system 1508, such as the messaging system 1510 and the video communication system 1512.

A media overlay may include text or image data that can be overlaid on top of a photograph taken by the AR system 1304 or a video stream produced by the AR system 1304. In some examples, the media overlay may be a location overlay (e.g., Venice beach), a name of a live event, or a name of a merchant overlay (e.g., Beach Coffee House). In further examples, the image processing system 1502 uses the geolocation of the AR system 1304 to identify a media overlay that includes the name of a merchant at the geolocation of the AR system 1304. The media overlay may include other indicia associated with the merchant. The media overlays may be stored in the databases 1324 and accessed through the database server 1322.

The image processing system 1502 provides a user-based publication platform that enables users to select a geolocation on a map and upload content associated with the selected geolocation. The user may also specify circumstances under which a particular media overlay should be offered to other users. The image processing system 1502 generates a media overlay that includes the uploaded content and associates the uploaded content with the selected geolocation.

The augmentation creation system 1514 supports augmented reality developer platforms and includes an application for content creators (e.g., artists and developers) to create and publish augmentations (e.g., augmented reality experiences) of the interaction client 1308. The augmentation creation system 1514 provides a library of built-in features and tools to content creators including, for example custom shaders, tracking technology, and templates.

In some examples, the augmentation creation system 1514 provides a merchant-based publication platform that enables merchants to select a particular augmentation associated with a geolocation via a bidding process. For example, the augmentation creation system 1514 associates a media overlay of the highest bidding merchant with a corresponding geolocation for a predefined amount of time.

A communication system 1508 is responsible for enabling and processing multiple forms of communication and interaction within the interaction system 1300 and includes a messaging system 1510, an audio communication system 1516, and a video communication system 1512. The messaging system 1510 is responsible for enforcing the temporary or time-limited access to content by the interaction clients 1308. The messaging system 1510 incorporates multiple timers (e.g., within an ephemeral timer system) that, based on duration and display parameters associated with a message or collection of messages (e.g., a story), selectively enable access (e.g., for presentation and display) to messages and associated content via the interaction client 1308. Further details regarding the operation of the ephemeral timer system are provided below. The audio communication system 1516 enables and supports audio communications (e.g., real-time audio chat) between multiple interaction clients 1308. Similarly, the video communication system 1512 enables and supports video communications (e.g., real-time video chat) between multiple interaction clients 1308.

A user management system 1518 is operationally responsible for the management of user data and profiles, and includes an entity relationship system that maintains entity relationship information regarding relationships between users of the interaction system 1300.

A collection management system 1520 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 1520 may also be responsible for publishing an icon that provides notification of a particular collection to the user interface of the interaction client 1308. The collection management system 1520 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 1520 employs machine vision (or image recognition technology) and content rules to curate a content collection automatically. In certain examples, compensation may be paid to a user to include user-generated content into a collection. In such cases, the collection management system 1520 operates to automatically make payments to such users to use their content.

A map system 1522 provides various geographic location functions and supports the presentation of map-based media content and messages by the interaction client 1308. For example, the map system 1522 enables the display of user icons or avatars (e.g., stored in profile data 1402) on a map to indicate a current or past location of “friends” of a user, as well as media content (e.g., collections of messages including photographs and videos) generated by such friends, within the context of a map. For example, a message posted by a user to the interaction system 1300 from a specific geographic location may be displayed within the context of a map at that particular location to “friends” of a specific user on a map interface of the interaction client 1308. A user can furthermore share his or her location and status information (e.g., using an appropriate status avatar) with other users of the interaction system 1300 via the interaction client 1308, with this location and status information being similarly displayed within the context of a map interface of the interaction client 1308 to selected users.

A game system 1524 provides various gaming functions within the context of the interaction client 1308. The interaction client 1308 provides a game interface providing a list of available games that can be launched by a user within the context of the interaction client 1308 and played with other users of the interaction system 1300. The interaction system 1300 further enables a particular user to invite other users to participate in the play of a specific game by issuing invitations to such other users from the interaction client 1308. The interaction client 1308 also supports audio, video, and text messaging (e.g., chats) within the context of gameplay, provides a leaderboard for the games, and also supports the provision of in-game rewards (e.g., coins and items).

An external resource system 1526 provides an interface for the interaction client 1308 to communicate with remote servers (e.g., third-party servers 1316) to launch or access external resources, i.e., applications or applets. Each third-party server 1316 hosts, for example, a markup language (e.g., HTML5) based application or a small-scale version of an application (e.g., game, utility, payment, or ride-sharing application). The interaction client 1308 may launch a web-based resource (e.g., application) by accessing the HTML5 file from the third-party servers 1316 associated with the web-based resource. Applications hosted by third-party servers 1316 are programmed in JavaScript leveraging a Software Development Kit (SDK) provided by the interaction servers 1326. The SDK includes Application Programming Interfaces (APIs) with functions that can be called or invoked by the web-based application. The interaction servers 1326 host a JavaScript library that provides a given external resource access to specific user data of the interaction client 1308. HTML5 is an example of technology for programming games, but applications and resources programmed based on other technologies can be used.

To integrate the functions of the SDK into the web-based resource, the SDK is downloaded by the third-party server 1316 from the interaction servers 1326 or is otherwise received by the third-party server 1316. Once downloaded or received, the SDK is included as part of the application code of a web-based external resource. The code of the web-based resource can then call or invoke certain functions of the SDK to integrate features of the interaction client 1308 into the web-based resource.

The SDK stored on the interaction server system 1314 effectively provides the bridge between an external resource (e.g., applications 1310 or applets) and the interaction client 1308. This gives the user a seamless experience of communicating with other users on the interaction client 1308 while also preserving the look and feel of the interaction client 1308. To bridge communications between an external resource and an interaction client 1308, the SDK facilitates communication between third-party servers 1316 and the interaction client 1308. A WebViewJavaScriptBridge running on an AR system 1304 establishes two one-way communication channels between an external resource and the interaction client 1308. Messages are sent between the external resource and the interaction client 1308 via these communication channels asynchronously. Each SDK function invocation is sent as a message and callback. Each SDK function is implemented by constructing a unique callback identifier and sending a message with that callback identifier.

By using the SDK, not all information from the interaction client 1308 is shared with third-party servers 1316. The SDK limits which information is shared based on the needs of the external resource. Each third-party server 1316 provides an HTML5 file corresponding to the web-based external resource to interaction servers 1326. The interaction servers 1326 can add a visual representation (such as a box art or other graphic) of the web-based external resource in the interaction client 1308. Once the user selects the visual representation or instructs the interaction client 1308 through a GUI of the interaction client 1308 to access features of the web-based external resource, the interaction client 1308 obtains the HTML5 file and instantiates the resources to access the features of the web-based external resource.

The interaction client 1308 presents a graphical user interface (e.g., a landing page or title screen) for an external resource. During, before, or after presenting the landing page or title screen, the interaction client 1308 determines whether the launched external resource has been previously authorized to access user data of the interaction client 1308. In response to determining that the launched external resource has been previously authorized to access user data of the interaction client 1308, the interaction client 1308 presents another graphical user interface of the external resource that includes functions and features of the external resource. In response to determining that the launched external resource has not been previously authorized to access user data of the interaction client 1308, after a threshold period of time (e.g., 3 seconds) of displaying the landing page or title screen of the external resource, the interaction client 1308 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 1308 adds the external resource to a list of authorized external resources and allows the external resource to access user data from the interaction client 1308. The external resource is authorized by the interaction client 1308 to access the user data under an OAuth 2 framework.

The interaction client 1308 controls the type of user data that is shared with external resources based on the type of external resource being authorized. For example, external resources that include full-scale applications (e.g., an application 1310) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 1528 operationally enables the purchasing of advertisements by third parties for presentation to end-users via the interaction clients 1308 and also handles the delivery and presentation of these advertisements.

### Software Architecture

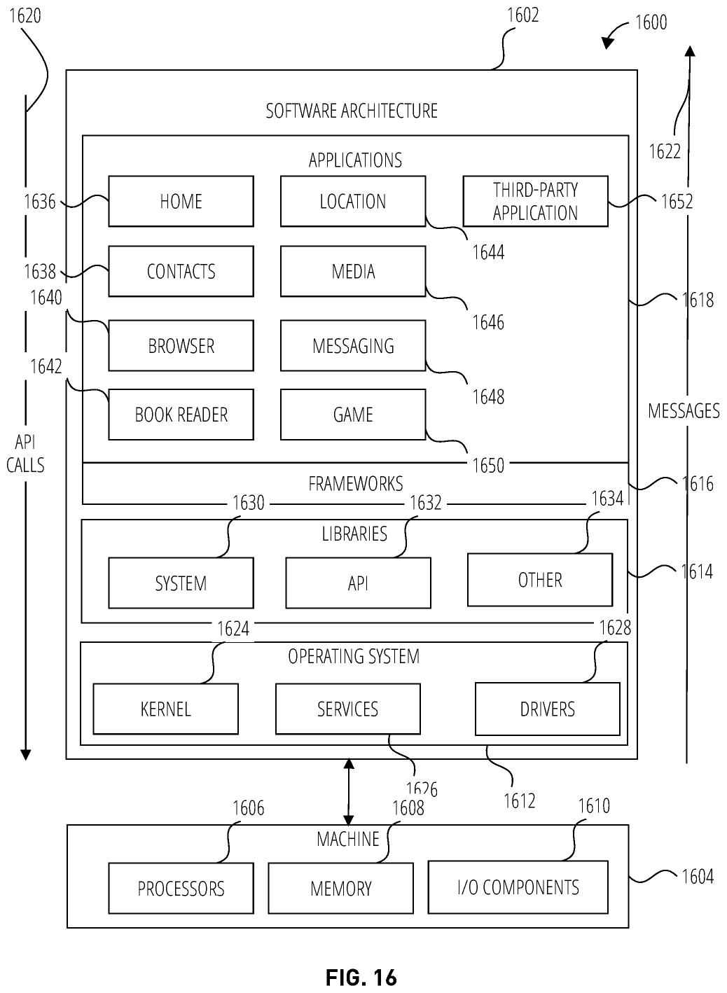

FIG. 16 is a block diagram 1600 illustrating a software architecture 1602, which can be installed on any one or more of the devices described herein. The software architecture 1602 is supported by hardware such as a machine 1604 that includes processors 1606, memory 1608, and I/O components 1610. In this example, the software architecture 1602 can be conceptualized as a stack of layers, where each layer provides a particular functionality. The software architecture 1602 includes layers such as an operating system 1612, libraries 1614, frameworks 1616, and applications 1618. Operationally, the applications 1618 invoke API calls 1620 through the software stack and receive messages 1622 in response to the API calls 1620.

The operating system 1612 manages hardware resources and provides common services. The operating system 1612 includes, for example, a kernel 1624, services 1626, and drivers 1628. The kernel 1624 acts as an abstraction layer between the hardware and the other software layers. For example, the kernel 1624 provides memory management, processor management (e.g., scheduling), component management, networking, and security settings, among other functionalities. The services 1626 can provide other common services for the other software layers. The drivers 1628 are responsible for controlling or interfacing with the underlying hardware. For instance, the drivers 1628 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1614 provide a common low-level infrastructure used by the applications 1618. The libraries 1614 can include system libraries 1630 (e.g., C standard library) that provide functions such as memory allocation functions, string manipulation functions, mathematic functions, and the like. In addition, the libraries 1614 can include API libraries 1632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1614 can also include a wide variety of other libraries 1634 to provide many other APIs to the applications 1618.

The frameworks 1616 provide a common high-level infrastructure that is used by the applications 1618. For example, the frameworks 1616 provide various graphical user interface (GUI) functions, high-level resource management, and high-level location services. The frameworks 1616 can provide a broad spectrum of other APIs that can be used by the applications 1618, some of which may be specific to a particular operating system or platform.

In an example, the applications 1618 may include a home application 1636, a contacts application 1638, a browser application 1640, a book reader application 1642, a location application 1644, a media application 1646, a messaging application 1648, a game application 1650, and a broad assortment of other applications such as a third-party application 1652. The applications 1618 are programs that execute functions defined in the programs. Various programming languages can be employed to create one or more of the applications 1618, structured in a variety of manners, such as object-oriented programming languages (e.g., Objective-C, Java, or C++) or procedural programming languages (e.g., C or assembly language). In a specific example, the third-party application 1652 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1652 can invoke the API calls 1620 provided by the operating system 1612 to facilitate functionalities described herein.

Additional examples include:

Example 1: A computer-implemented method including: providing, by one or more processors, an Augmented Reality (AR) user interface of an AR system to a user, the AR user interface displayed on a display screen, capturing, by the one or more processors, using one or more cameras, scene image data of a real-world scene including the user, generating, by the one or more processors, pre-processed scene image data using the scene image data, generating, by the one or more processors, restored scene image data using the pre-processed scene image data and a model trained to restore the scene image data, generating, by the one or more processors, mirror image data using the restored scene image data, generating, by the one or more processors, AR mirror image data using the mirror image data, and providing, by the one or more processors, an AR mirror image to the user using the AR mirror image data and the AR user interface.

Example 2: The computer-implemented method of Example 1, further comprising: capturing, by the one or more processors, using one or more scene-reference cameras of the AR system, reference scene image data.

Example 3: The computer-implemented method of any of Examples 1-2, wherein generating the pre-processed scene image data further uses the reference scene image data.

Example 4: The computer-implemented method of any of Examples 1-3, wherein generating the mirror image data further uses the reference scene image data.

Example 5: The computer-implemented method of any of Examples 1-4, further comprising: capturing, by the one or more processors, using one or more user-reference cameras, user image data, determining, by the one or more processors, an eye level of the user using the user image data, and positioning, by the one or more processors, the one or more cameras at the eye level of the user using the eye level of the user.

Example 6: The computer-implemented method of any of Examples 1-5, wherein generating the AR mirror image data includes: detecting a user image in the mirror image data, and overlaying a virtual object on the user image.

Example 7: The computer-implemented method of any of Examples 1-6, wherein the display screen is a see-through display screen, and wherein the one or more cameras are positioned behind the display screen to capture the scene image data.

Example 8: At least one machine-readable medium including instructions that, when executed by processing circuitry, cause the processing circuitry to perform operations to implement any of Examples 1-7.

Example 9: An apparatus comprising means to implement any of Examples 1-7.

Example 10: A system to implement any of Examples 1-7.

### CONCLUSION

Changes and modifications may be made to the disclosed examples without departing from the scope of the present disclosure. These and other changes or modifications are intended to be included within the scope of the present disclosure, as expressed in the following claims.

### Glossary

“Carrier signal” refers to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component includes a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Machine-readable storage medium” refers to both machine-storage media and transmission media. Thus, the terms include both storage devices/media and carrier waves/modulated data signals. The terms “computer-readable medium,” “machine-readable medium” and “device-readable medium” mean the same thing and may be used interchangeably in this disclosure.

“Machine-storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

Changes and modifications may be made to the disclosed examples without departing from the scope of the present disclosure. These and other changes or modifications are intended to be included within the scope of the present disclosure, as expressed in the following claims.

What is claimed is:

1. A computer-implemented method comprising:
providing, by one or more processors, an Augmented Reality (AR) user interface of an AR system to a user, the AR user interface displayed on a display screen;
capturing, by the one or more processors, using one or more cameras, scene image data of a real-world scene including the user;
generating, by the one or more processors, pre-processed scene image data using the scene image data;
generating, by the one or more processors, restored scene image data using the pre-processed scene image data and a model trained to restore the scene image data;
generating, by the one or more processors, mirror image data using the restored scene image data;
generating, by the one or more processors, AR mirror image data using the mirror image data; and
providing, by the one or more processors, an AR mirror image to the user using the AR mirror image data and the AR user interface.

2. The computer-implemented method of claim 1, further comprising:
capturing, by the one or more processors, using one or more scene-reference cameras of the AR system, reference scene image data.

3. The computer-implemented method of claim 2, wherein generating the pre-processed scene image data further uses the reference scene image data.

4. The computer-implemented method of claim 3, wherein generating the mirror image data further uses the reference scene image data.

5. The computer-implemented method of claim 1, further comprising:
capturing, by the one or more processors, using one or more user-reference cameras, user image data;
determining, by the one or more processors, an eye level of the user using the user image data; and
positioning, by the one or more processors, the one or more cameras at the eye level of the user using the eye level of the user.

6. The computer-implemented method of claim 1, wherein generating the AR mirror image data comprises:
detecting a user image in the mirror image data; and
overlaying a virtual object on the user image.

7. The computer-implemented method of claim 1, wherein the display screen is a see-through display screen, and wherein the one or more cameras are positioned behind the display screen to capture the scene image data.

8. A machine comprising:
one or more processors; and
a memory storing instructions that, when executed by the one or more processors, cause the machine to perform operations comprising:
providing an Augmented Reality (AR) user interface of an AR system to a user, the AR user interface displayed on a display screen;
capturing using one or more cameras, scene image data of a real-world scene including the user;
generating pre-processed scene image data using the scene image data;
generating restored scene image data using the pre-processed scene image data and a model trained to restore the scene image data;
generating mirror image data using the restored scene image data;
generating AR mirror image data using the mirror image data; and
providing an AR mirror image to the user using the AR mirror image data and the AR user interface.

9. The machine of claim 8, wherein the operations further comprise:
capturing, using one or more scene-reference cameras of the AR system, reference scene image data.

10. The machine of claim 9, wherein generating the pre-processed scene image data further uses the reference scene image data.

11. The machine of claim 10, wherein generating the mirror image data further uses the reference scene image data.

12. The machine of claim 8, wherein the operations further comprise:
capturing, using one or more user-reference cameras, user image data;
determining an eye level of the user using the user image data; and
positioning the one or more cameras at the eye level of the user using the eye level of the user.

13. The machine of claim 8, wherein generating the AR mirror image data comprises:
detecting a user image in the mirror image data; and
overlaying a virtual object on the user image.

14. The machine of claim 8, wherein the display screen is a see-through display screen, and wherein the one or more cameras are positioned behind the display screen to capture the scene image data.

15. A machine-readable storage medium, the machine-readable storage medium including instructions that, when executed by a machine, cause the machine to perform operations comprising:
providing an Augmented Reality (AR) user interface of an AR system to a user, the AR user interface displayed on a display screen;
capturing using one or more cameras, scene image data of a real-world scene including the user;
generating pre-processed scene image data using the scene image data;
generating restored scene image data using the pre-processed scene image data and a model trained to restore the scene image data;
generating mirror image data using the restored scene image data;
generating AR mirror image data using the mirror image data; and
providing an AR mirror image to the user using the AR mirror image data and the AR user interface.

16. The machine-readable storage medium of claim 15, wherein the operations further comprise:
capturing, using one or more scene-reference cameras of the AR system, reference scene image data.

17. The machine-readable storage medium of claim 16, wherein generating the pre-processed scene image data further uses the reference scene image data.

18. The machine-readable storage medium of claim 17, wherein generating the mirror image data further uses the reference scene image data.

19. The machine-readable storage medium of claim 15, wherein the operations further comprise:
capturing, using one or more user-reference cameras, user image data;
determining an eye level of the user using the user image data; and
positioning the one or more cameras at the eye level of the user using the eye level of the user.

20. The machine-readable storage medium of claim 15, wherein generating the AR mirror image data comprises:
detecting a user image in the mirror image data; and
overlaying a virtual object on the user image.
